(19) United States
(12) Patent Application Publication
(10) Pub. No.: US 2022/0248679 A1
(43) Pub. Date: Aug. 11, 2022

(54) SYSTEM FOR PROMOTING PLANT GROWTH AND PRODUCTION

(71) Applicant: The Agricultural Gas Company, Petaluma, CA (US)

(72) Inventor: Stewart E. Erickson, Ventura, CA (US)

(21) Appl. No.: 17/443,783

(22) Filed: Jul. 27, 2021

Related U.S. Application Data
(63) Continuation-in-part of application No. 15/934,693, filed on Mar. 23, 2018, now Pat. No. 11,071,257.
(60) Provisional application No. 62/475,258, filed on Mar. 23, 2017.

(51) Int. Cl. A01N 59/00

(52) U.S. Cl. CPC A01N 59/00

(57) ABSTRACT

A system for applying CO₂ gas to improve Cannabis and other crop production. A multi-stage system is disclosed including upstream, midstream, and downstream stages or subsystems. The upstream subsystem receives and stores gas, particularly CO2 gas. The midstream subsystem is communicatively connected to the upstream subsystem and to the downstream subsystem. It monitors the environment of the downstream subsystem, determines when and how to apply gas to plants growing in the downstream system, acquires gas stored in the upstream subsystem, and distributes it to the downstream system. It also has various monitoring, command and control, management, and reporting features. The downstream subsystem includes one or more plant growth areas or plots, gas distribution means, such as gas conduits, tubes or lines from the midstream subsystem, and the high efficiency, adjustable gas applicator, and various sensing and monitoring devices communicatively connected to the midstream subsystem.

### CROSS-REFERENCE TO RELATED APPLICATIONS, IF ANY

This application is a Continuation In Part of U.S. patent application Ser. No. 15/934,693, filed Mar. 23, 2018, status pending, which claims the benefit under 35 U.S.C. § 119(e) of co-pending U.S. Provisional Patent Application Ser. No. 62/475,258, filed Mar. 23, 2017, both of which are hereby incorporated by reference.

### 37 C.F.R. § 1.71(e) AUTHORIZATION

A portion of the disclosure of this patent document contains material which is subject to copyright protection. The copyright owner has no objection to the facsimile reproduction by anyone of the patent document or the patent disclosure, as it appears in the US Patent and Trademark Office patent file or records, but otherwise reserves all copyright rights whatsoever.

### STATEMENT REGARDING FEDERALLY SPONSORED RESEARCH OR DEVELOPMENT

Not applicable.

### REFERENCE TO A MICROFICHE APPENDIX, IF ANY

Not applicable.

### BACKGROUND OF THE INVENTION

### 1. Field of the Invention

The present invention relates, generally, to agricultural systems, apparatus and methods. Particularly, the invention relates to a system of delivering gases to crops. More particularly, the invention relates to an integrated, self-supporting CO2 gas delivery system. Most particularly, the system is useable to promote plant growth and production in Cannabis.

### 2. Background Information

Hoop houses are generally about 60′ long, with some be much longer or greenhouses being much longer providing the overall bed length for planting of crops such as Cannabis. Long beds of Cannabis and other crops of this configuration are also planted outdoors.

Existing technology in this field is believed to have significant limitations and shortcomings. For this and other reasons, a need exists for the present invention.

All US patents and patent applications, and all other published documents mentioned anywhere in this application are incorporated by reference in their entirety.

### BRIEF SUMMARY OF THE INVENTION

The invention provides an agricultural system, apparatus, and method which are beneficial, practical, reliable, and efficient, and which are believed to fulfill the need and to constitute an improvement over the background technology.

In one aspect, the invention provides a system for applying CO2 gas to improve Cannabis production. A multi-stage system is disclosed including upstream, midstream, and downstream stages or subsystems. The upstream subsystem receives and stores gas, particularly CO2 gas. The midstream subsystem is communicatively connected to the upstream subsystem and to the downstream subsystem. It monitors the environment of the downstream subsystem, determines when and how to apply gas to plants growing in the downstream system, acquires gas stored in the upstream subsystem, and distributes it to the downstream system. It also has various monitoring, command arid control, management, and reporting features. The downstream subsystem includes one or more plant growth areas or plots, gas distribution means, such as gas conduits, tubes or lines from the midstream subsystem, and the high efficiency, adjustable gas applicator, and various sensing and monitoring devices communicatively connected to the midstream subsystem.

In another aspect, the invention provides alternative CO2 sources and interconnections. When, for example, the transportation distance from the CO2 source to the farm is less than 100 miles, liquidation of the CO₂ may be avoided due to cost rationale, and highly-compressed CO2 gas may be transported and filled into a storage tank on site at the farm. Handling highly-compressed, gaseous CO2 can eliminated the need for the associated vaporizer and pressure builder as the CO2 is maintained in a gaseous state. Highly-compressed CO2 trucks are commonly referred to as “Torpedo Trucks” as the trailer looks like a series of torpedo tubes.

In another aspect, the invention provides alternative emitter configurations.

The aspects, features, advantages, benefits and objects of the invention will become clear to those skilled in the art by reference to the following description, claims and drawings.

### BRIEF DESCRIPTION OF THE SEVERAL VIEWS OF THE DRAWING

FIG. 1 is a diagram of an embodiment of the system of the invention, including upstream, midstream and downstream subsystems, features and components.

FIG. 2 is a more detailed diagrammatic view embodiments of the upstream and midstream subsystems, and their features and components.

FIG. 3 is a plan view of an embodiment of the a hoop house and downstream components of the invention.

FIG. 4 is a side elevation view of the components and features of FIG. 3.

FIG. 5 is an end view of the components and features of FIGS. 3 and 4.

FIG. 6 is a perspective showing of a hoop house farm embodiment of the invention, including plural hoop houses laid out in rows and columns.

FIG. 7 shows an embodiment of the upstream and midstream components and features of the invention, including a gas storage tank being filled by a gas transportation truck, a trailer containing various gas and electronic control features, and a solar power array.

FIG. 8 shows an embodiment of the upstream components and features of the invention, including a gas storage tank, a pressure builder and a vaporizer.

FIG. 9 shows an embodiment of a planter contained within the hoop house and including a pair of gas emitter lines operatively disposed above plants growing within media in the planter.

FIG. 10 is a perspective view of an embodiment of a gas distribution and emission assembly for use with a single planter, the assembly including a gas distribution manifold, a pair of gas emission lines communicatively connected to the manifold, and a middle support mechanism having a horizontal support mechanism disposed in a fixed position.

FIG. 11 illustrates an alternative embodiment of the gas distribution and emission assembly, including an alternative embodiment of the middle support mechanism, including a cantilevered arm disposed in a fixed position.

FIG. 12 is illustrates another alternative embodiment of the gas distribution and emission assembly, including an alternative embodiment of the middle support mechanism, including another embodiment of a cantilevered arm.

FIG. 13 illustrates yet another embodiment of a cantilevered arm including a crossover manifold center.

FIG. 14 illustrates still another embodiment of a cantilevered arm, including a cross over manifold center support.

FIG. 15 illustrates an embodiment of a cantilevered arm including a crossover manifold center support solid brace.

FIG. 16 illustrates an embodiment of the system of the invention, including a plant support mesh feature.

FIG. 17 shows an embodiment of a vertically adjustable gas emission line tensioning support.

FIG. 18 shows an embodiment of a horizontal support mechanism.

FIG. 19 is a more detailed illustration of an embodiment of a gas distribution manifold including a bed shut off feature.

FIG. 20 is a detailed illustration of an alternative embodiment of the gas distribution manifold, including bed shut off and adjustable flow.

FIG. 21 is a detailed illustration of another alternative embodiment of the gas distribution manifold, with more basic features.

FIG. 22 is a front view of an embodiment of a gas control manifold assembly, which is part of the midstream aspect of the invention.

FIG. 23 is a side view of the gas control manifold assembly of FIG. 22.

FIG. 24 is a top view of the gas control manifold assembly of FIGS. 22 and 23.

FIG. 25 is a front view of an embodiment of a gas input valve assembly.

FIG. 26 is a side view of the gas input valve assembly.

FIG. 27 is a from view of an embodiment of a gas output valve assembly.

FIG. 28 is a side view of the gas output valve assembly.

FIG. 29 shows an embodiment of a user interface control panel home page.

FIG. 30 shows an embodiment of the user interface control panel CO2 status page.

FIG. 31 shows an embodiment of the user interface control panel weather status page.

FIG. 32 shows an embodiment of the user interface control panel gas flow status page.

FIG. 33 shows an embodiment of a power control module of the invention.

FIG. 34 is a diagram showing an embodiment of a sensor module control and communication system of the invention, including WIFI capability.

FIG. 35 is a diagram of an embodiment of a hoop house electrical and communication system.

FIG. 36 is a diagram of an embodiment of a LoRa, WIFI, battery and power management module of the invention.

FIG. 37 illustrates an embodiment of a pressure sensor housing of the invention.

FIG. 38 illustrates the adjustability function and features of the system of the invention during the life cycle of plants processed from clones, juvenile, to mature flowering stage for Cannabis.

FIG. 39 is a diagrammatic view an alternative embodiment of the system of the invention including upstream and midstream subsystems, and their features and components.

FIG. 40 is a diagrammatic view a further alternative embodiment of the system of the invention including upstream and midstream subsystems, and their features and components.

FIG. 41 shows a delivery vehicle communicatively attached to an on-site tank.

FIG. 42 is a map of natural gas pipelines in California.

FIG. 43 is a map of power plants in California.

FIG. 44 is a graph illustrating the growth of bioenergy.

FIG. 45 shows an embodiment of drip tape useable in an embodiment of the system.

FIG. 46 shows an alternative emitter.

FIG. 47 shows an emitter conduit.

FIG. 48 shows a woodpecker.

### DETAILED DESCRIPTION

The present invention provides a system, apparatus, and methods for enhancing the growth of plants, particularly Cannabis, and most particularly Cannabis grown in green houses, hoop houses, and the like, in open air. The invention utilizes Carbon Dioxide gas (CO2 or CO₂). The invention administers the gas in close proximity to plains growing in groups or plots so that the plants receive a maximum beneficial amount of the gas. for the longest reasonably possible time period. This also reduces cost to the grower. The system is able to maintain that close proximity distribution by various means including freight adjustment means that permit the grower to easily adjust gas application height throughout the plant growth life cycle from seedlings or clones, juveniles, to mature plants ready for harvest. Further, the system permits fast and easy retraction at harvest time so that the gas distribution and application devices do not interfere with harvest tasks, whether manually or mechanized, lire system is optimized to provide full monitoring and control of gas application, coordinated with light exposure, temperature, watering, fertilizing and the like. The system may be integrated with lighting, heating, watering and feeding system. Alternatively, it may be readily retrofitted to existing systems and devices.

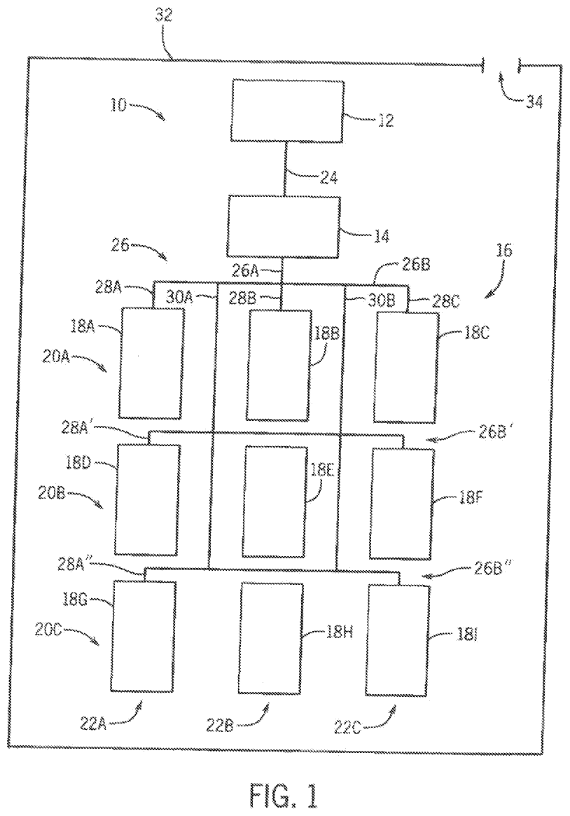

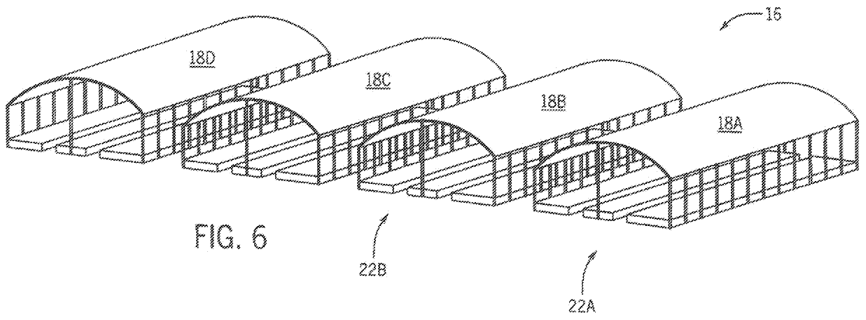

Referring to FIGS. 1 and 6, one embodiment of the system 10 of the invention is a multi-stage system which basically comprises upstream 12, midstream 14 and downstream i6 stages or subsystems. The upstream subsystem 12 receives and stores gas, particularly CO2 gas. The midstream subsystem 14 is communicatively connected to the upstream subsystem 12 and to the downstream subsystem 16. It monitors the environment of the downstream subsystem 16. determines when and how to apply gas to plants growing in the downstream system 16, acquires gas stored in the upstream subsystem 12, and distributes it to the downstream system 16. It also has various monitoring, command and control, management, and reporting features. The downstream subsystem 16 comprises one or more plant growth areas or plots, gas distribution means, such as gas conduits, tubes or lines from the midstream subsystem, and the high efficiency, adjustable gas application means, and various sensing and monitoring means communicatively connected to the midstream subsystem.

In this embodiment, the plant growth plot or plots are preferably relatively compact, sheltered environments such as green houses or greenhouses. Most particularly, the green houses are hoop-type houses that arc easy to construct from basic materials such as dimensional lumber, PVC plastic conduit, lightweight but ridged metal tubing and the like for base structures. They typically have roofs or tops, most often constructed of transparent or semi transparent, thin, flexible plastic material. The plastic sheet or sheets arc placed over and supported by hoop supports (typically curved to shed rain, wind, snow and the like) placed at predetermined distances apart, which are supported by the base structure. The sheets are typically stretched tight over the roof hoop supports to aid in shedding the element, but also to reduce noise from flapping in the wind, and to improve structural integrity Houses typically have side and end walls. Such walls may be adjusted or removed depending up temperature, climate and other factors, lire walls are also typically constructed of flexible materials, most typically transparent or semi transparent materials. Hoop houses commonly are constructed on grade and have rectangular floor plans. Plants may be grown on grade, with existing soil (enhanced or not) or other media. The system may also be applied to houses constructed on slabs of concrete, asphalt or other non-soil substrates. Lastly the system may be deployed in existing interior structures such as permanent greenhouses, warehouses, and other structures. A preferred embodiment utilizes plant boxes constructed of dimensional lumber such as 2×12s, and filled with a plant growth media composed of soil, and other materials beneficial to plant growth. Hoop houses may be provided with irrigation systems, light systems, heating systems, power, and the like. Although the invention is described in the context of a hoop houses, it is within the purview of the invention that the systems, apparatus and methods may be applicable to green houses or outside in open fields, orchards, vineyards and the like.

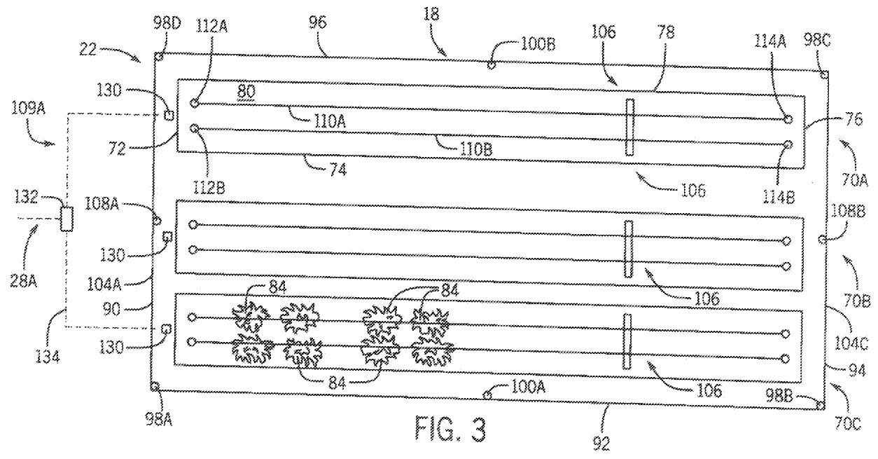

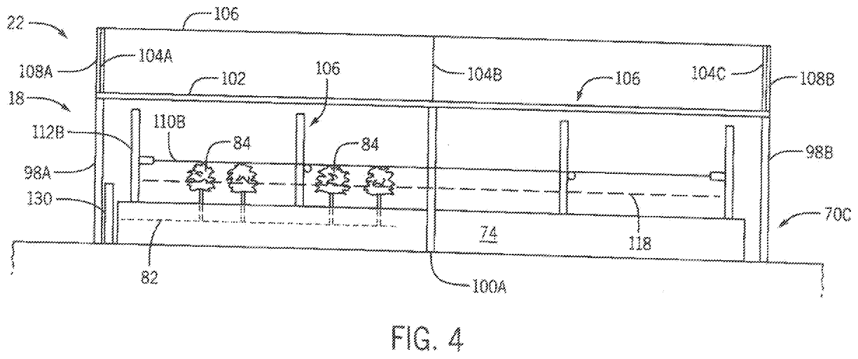

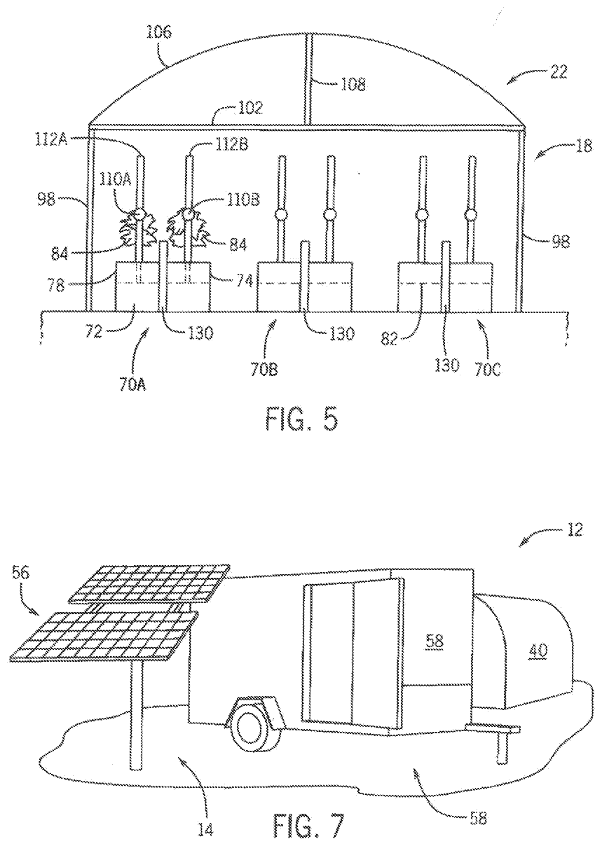

In the preferred embodiments shown in FIG. 1, the downstream subsection 16 consists of multiple hoop houses constituting a farm, with plural houses 18 A-I arranged in rows 20 A-C and columns 22 A-C. Paths exist between rows 20 and columns 22 of houses 18 for convenient movement of stall, equipment, material and harvested crops. Referring also to FIGS. 3-5, the hoop houses 18 have an elongated, rectangular configuration with first or proximal, and second or distal end walls 90 and 94, respectively, and side walls 92 and 96. Walls 90-96 are supported by corner posts or anchors 98A-D and a plurality of mid posts 100, the number of which depend upon the length of the house 18. The vertical walls 90-96 have a peripheral top plate 102. Curved, roof hoops 104 extend from one side of the plate 102 to the other. Roof material 106 is supported by the hoops 104. The roof may be supported at its ends by one or more end supports 108.

The exemplary houses 18 for growing Cannabis have a length of approximately sixty (60) feet (18.28 meters), a width of fifteen (15) ft. (4.57-m), and a height of five (5) ft. (1.52 in.) measured at the base wall and nine (9) ft. (2.74 m.) at the apex of the hoop. In the preferred embodiment, the downstream stage or farm 16 of hoop houses 18 is disposed within a fence 32 or other security structure. Ingress and egress occurs though one or more gates 34. Although the invention has been described as including house or hoop house structures, it is within the purview of the invention that the system may be implemented for plant row disposed completely outdoors.

The upstream subsystem 12 is communicatively connected to the midstream 14 subsystem via gas, electrical and data lines conduits 24 Gas distributed by the midstream subsection 14 is output at a main supply line 26A. Depending upon the layout of the elements of the downstream subsection 16, the main supply 26A may be divided by a lateral trunk 26ft and supply individual plots 18A-C via plot lines 28A-C. Gas may extend to plots 18D-I disposed in columns behind a first row 20A of plots 18A-C via longitudinal feed lines 30A-B, and then to further lateral trunks 26B′ and 26B″. Although the layout of plots 18 in the downstream subsection have been shown rectilinearly, they may be disposed in various other linear or non-linear arrangements. Gas lines 24, 26, 28. and 30 are preferably buried, but they may be disposed above grade.

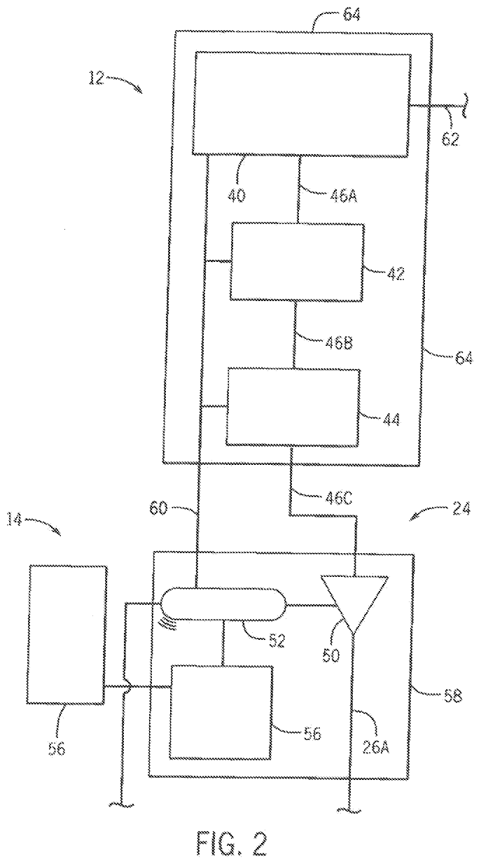

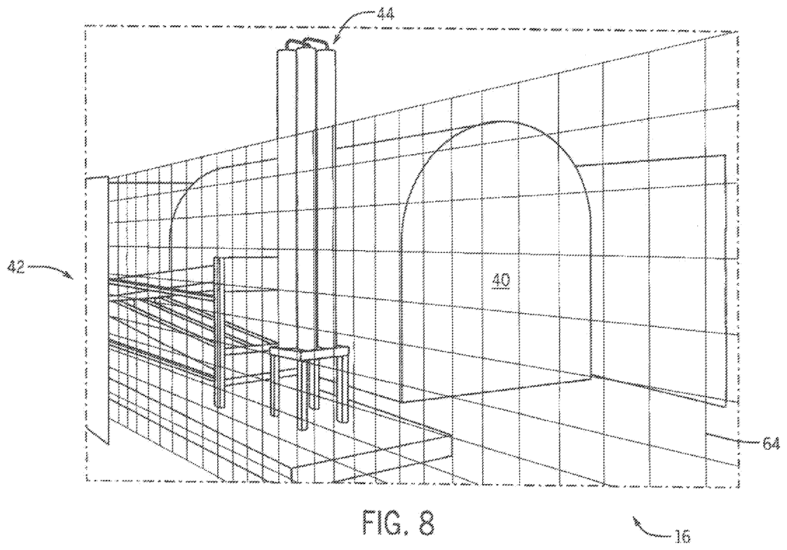

A preferred embodiment of the upstream subsection 12 is shown in FIGS. 2, 7 and 8. The subsection 12 preferably comprises a tank 40, a pressure builder 42, and a vaporizer 44. The tank 40 holds liquid Carbon Dioxide (CO2). It has a bulk storage capacity of between 5 and 50 Tons of liquefied CO2. It is within the purview of the invention that CO2 may be supplied in smaller quantiles such as 1,000 pound Dewers. And the system may be deployed in close proximity to a CO2 manufacturing facility (i.e. an ethanol, ammonia or power generating plant) and be directly supplied therefrom in gaseous form. An exemplary tank is manufactured by Chart Industries of New Prague, Minn., USA. The tank 40 has a fill inlet 62. The pressure builder 42 is connected to the tank 40 via line 46A. An exemplary pressure builder 42 is manufactured by Air Products of Allentown, Pa., USA. The vaporizer 44 is connected to the pressure builder 42 via line 46B. It functions to convert CO2 in a liquid state into CO2 in a gaseous stale. CO2 gas exits outlet 46C at a pressure of between 200 and 400 psi., preferably 300 psi. An example vaporizer 44 is available from Doucette Industries of York, Pa., USA. The upstream subassembly 12 is preferably secured by it's own security fence 64.

Still referring to FIG. 2, a preferred embodiment of midstream subsection 14 comprises a valve assembly 50, an electronic control assembly 52, and a power supply 54. These components are preferably located in a secure housing. In the preferred embodiment, they are shown disposed in a trailer 58. The valve assembly 50 is connected to the output 46C of the upstream assembly 12 and controls distribution of CO2 gas to the downstream system 16 via output 26A. The electronic control assembly 52 is communicatively connected to the valve assembly 50 and provides instructions to it distribution of gas. The electronic control assembly 52 is powered by power supply 54. The power supply 54 preferably contains batteries and AC power connections. The midstream section 14 also preferably has a solar array 56 for recharging the batteries of the power supply 54. The electronic control assembly 52 preferably has both direct wire connections and wireless (WIFI, RF or the like) connections to various sensors (temperature, humidity, CO2 concentration, light) disposed in the downstream section 16. The electronic control assembly 52 also preferably has means to connect remotely via hardwire telephone, CDMA cell and/or satellite transmission.

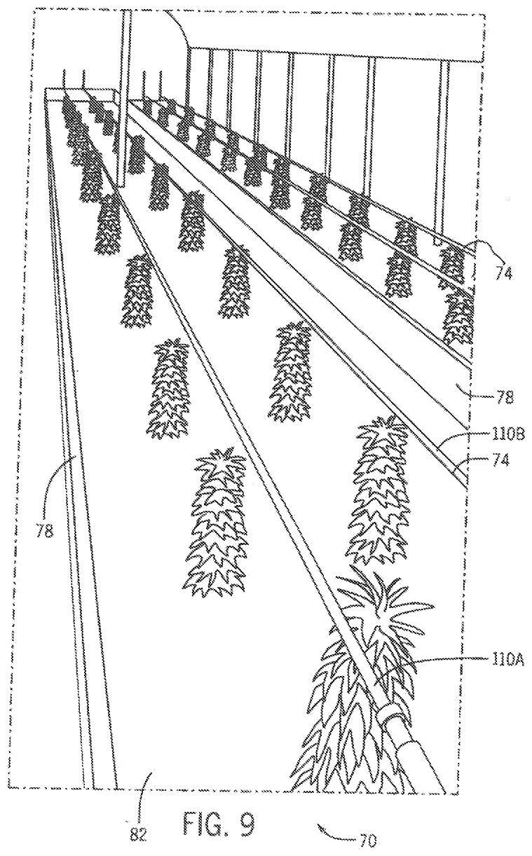

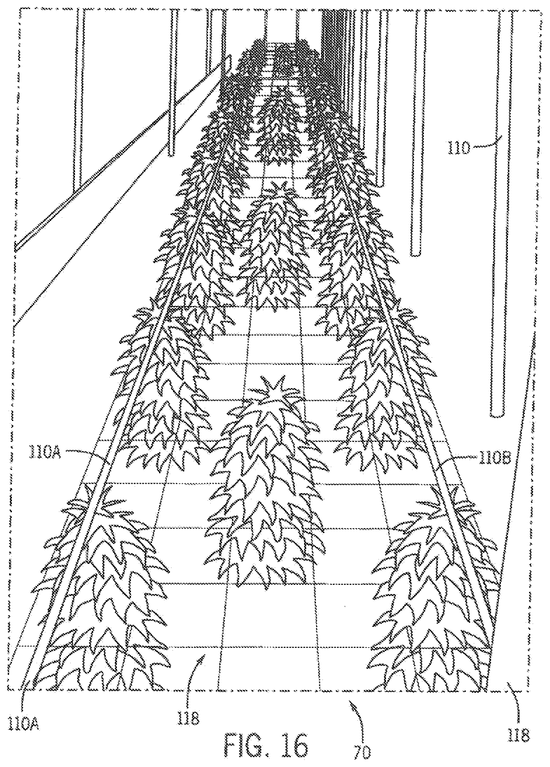

Referring to FIGS. 3-6 and 9, and 16, the individual hoop houses 18 of the downstream section 16 include plural, for example three (3) beds 70A-C. The beds 70, preferably have an elongated, rectangular configuration, with proximal and distal end walls 72 and 78 and side walls 74 and 76 surrounding a central planting area 80. The planting area 80 may utilize existing soils, on grade or built up, or preferably contains a particular planting media 82. The beds 70 have a thickness or depth of between 6 and 18 inches, preferably about 10 in. when 2×12 dimensional lumber is used for the walls 72-78. Media 82 substantially fills the planting area 80 to a depth of approximately 9 in. As is best shown in FIGS. 9 and 16, once the beds 70 are planted with seeds, seedlings, clones or other small plants 84, mulch (such as straw) may be applied to the beds 70, covering the planting area 80 between the individual plants 84. A stabilizing mesh 118 may then be applied, covering the planting area 80. Although the beds have been described as being constructed on the floor of a hoop house or the like, it is within the purview of the invention that the beds could be laid out on tables or other elevated structures containing natural or artificial soils, or liquid media, such as in trays, pots, pods or the like.

In the embodiment shown, paths exist between beds for movement of staff, equipment, material and harvested crops. However, the intra bed paths are small and tight so that maximum space inside the house is devoted to plant growth. Because of this, applicants' invention has a means of maintaining clear paths or rendering them clear during maintenance or harvest. The exemplary bed for growing Cannabis have a length of approximately 58 feet (17.67 meters), a width of 3 ft. (0.91 m.), and a bed height of about 1 ft. (0.30 m.). This yields a planting area 80 of approximately 180 square feet. The intra bed paths are approximately 18 in. (0.45 m.) wide. Ingress and egress occurs though one or both, ends of the hoop house.

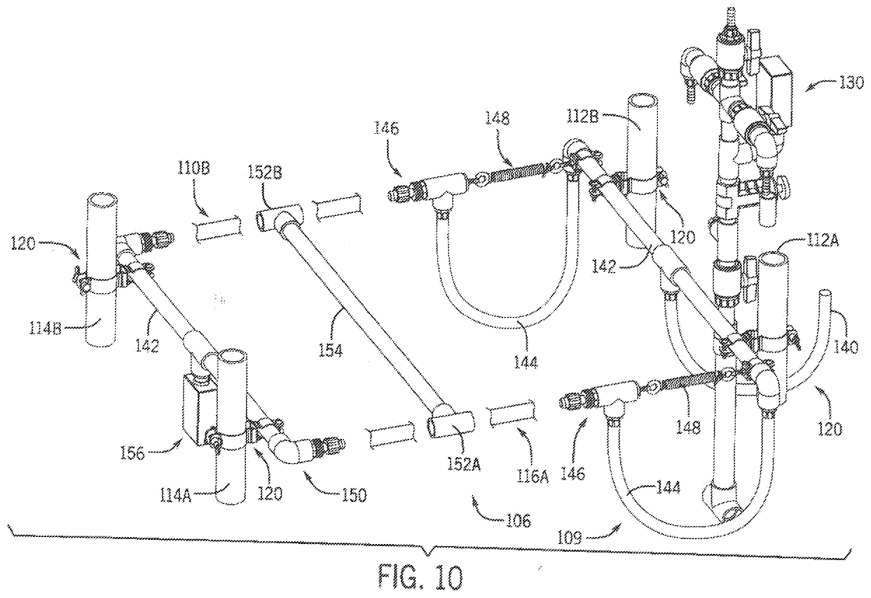

Significantly, each bed 70 includes a gas emission assembly 109. Referring also to FIG. 10, one embodiment of the gas emission assembly 109 includes a bed distribution manifold 130 and at least one gas emission line, tube or conduit 110. In the preferred embodiment, a pair of lines 110A-B is utilized. The gas distribution manifold 130 is disposed at the first or proximal end of the bed 70, nearest the up and midstream sub systems 12 and 14, and receives gas therefrom. Referring again to FIG. 3, for house 18 having plural bed 70, the manifold 130 for each bed may receive gas from a hoop house distribution splitter or manifold 132 (connected to the main gas line 28A) via supply lines 134. Lines 134 may be buried under the soil. Emission lines 110 are elongated and extend essentially the entire length of each bed 70. Lines 110 A and B are disposed a predetermined distance apart, preferably 12 in., the lines also being equally spaced from the sides of die bed 70. Referring also to FIG. 10, lines 110 are tubes having a central gas lumen and a plurality of emission apertures or orifices 116 which emit CO2 gas to the plants 84. The lines 110 are preferably constructed of a flexible plastic material and have an outside diameter of ⅝ in. The apertures are preferably slits having a length of between 1/84 to ¾ in. Alternatively, they may have a circular configuration and have a diameter of between 1/84 to ¾ in. The lines 110 are supported at each end by end posts 112 and 114. The line 110 ends are connected to tire posts 112 and 114 via at least one tension adjustment assembly 148 at each line 110 end. The tensioners 148 are preferably spring bias type tensioners. Tensioners 148 may be disposed at only one, or both ends of each line 110. In the embodiment of FIG. 10, the lines 110 are indirectly connected to the posts 112 and 114 via lateral members 142. Direct connection may be made in the alternative. The lateral members 142 also function to distribute and circulate gas. The proximal member 142 is shown to be communicatively connected to the manifold 130 via gas line 140. Proximal member 142 is then connected to each line 110A-B via flexible litres 144 and coupler assemblies 146. In view of the length and flexibility of the emission lines 110, at least one lateral mid support assembly 106 is disposed along the length of the lines 110, typically at the mid or halfway point of the length of the lines 110. The lateral support preferably extends below and supports both lines 110A-B for ease of adjustment. A CO2 gas line pressure sensor 156 is preferably connected in line with the assembly 130, preferably at the downstream end. This embodiment of the assembly 130 utilizes a continuous loop lumen from end to end. Alternatively, the gas lines 110 A/B may terminate at the distal end whereby all gas is emitted front the line apertures and does not circulate.

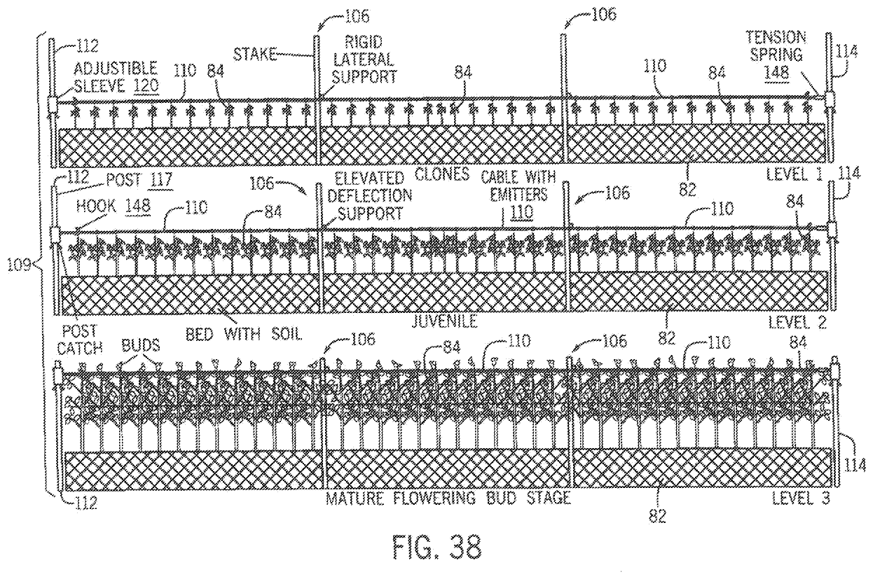

Importantly, the gas emission assemblies 109 are height adjustable so that the lines may be disposed close the plants 84 as they grow. Referring also to FIG. 38, typically, the lines 110 will be oriented just above the tops of the plants. In the embodiment of FIG. 10, the height adjustment means includes an adjustable connector, such as a strap, 120 coupled to each end post 112-114. The mid lateral supports 106 are similarly, adjustably supported by supports, such as posts (not shown). The straps 120 each have two (2) strap members, one for attaching to a vertical post 112/114, and one for attaching to a horizontal lateral member 142, and the two strap members are connected or attached to a swivel member whereby they may rotate in a position other than perpendicular (as shown). This permit adjustment of the entire gas line assembly either flat (as shown) or tilted, during height adjustment. This is beneficial when plants grow disproportionally in the beds or other row configurations 70.

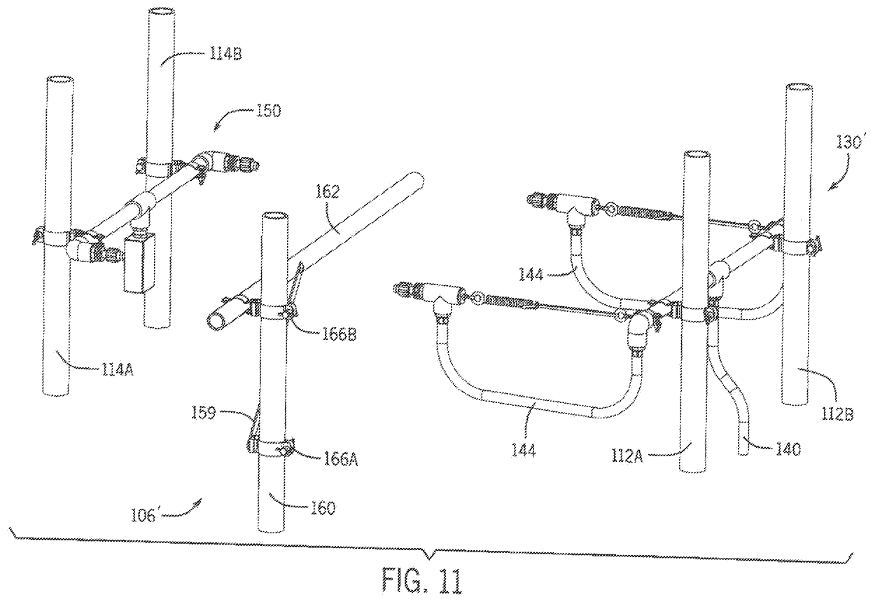

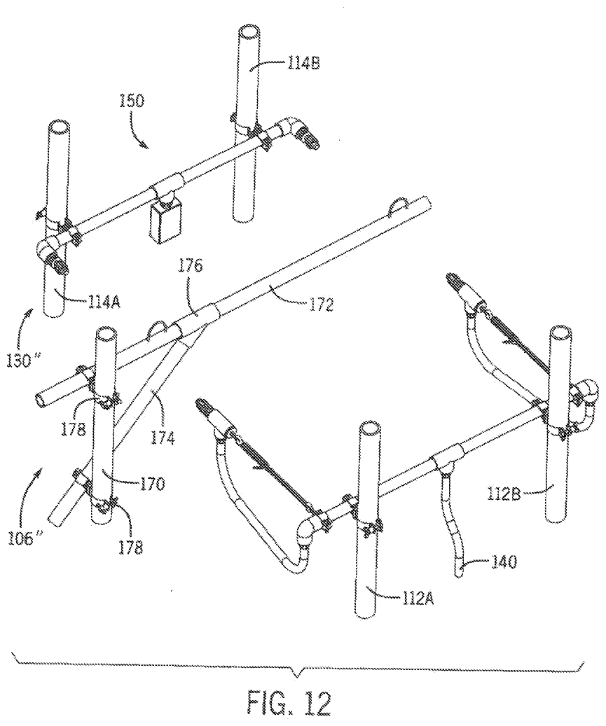

Further embodiments of the height adjustable distribution and emission assembly are shown in FIGS. 11 and 12. Referring first to FIG. 11, the assembly 130′ (prime) comprises substantially similar elements, with the exception of the mid lateral support 106′ (prime ) which has a vertical support 160, a cantilevered lateral support 162, and an angle member 164 adjustably coupled to the vertical member 160 via straps 166A/D. The straps 166 are also pivotable like straps 120 shown in FIG. 10. This embodiment of the assembly 130′ permits pivoting of live members out of the way of the paths between beds during maintenance and harvest. In FIG. 12, the assembly 130″ (double prime), again has substantially similar components, except that the mid lateral support has a vertical member 170, a horizontal member 172, an angle member 174 connected to the vertical member by a fitting 176, and height adjustable coupling straps 178.

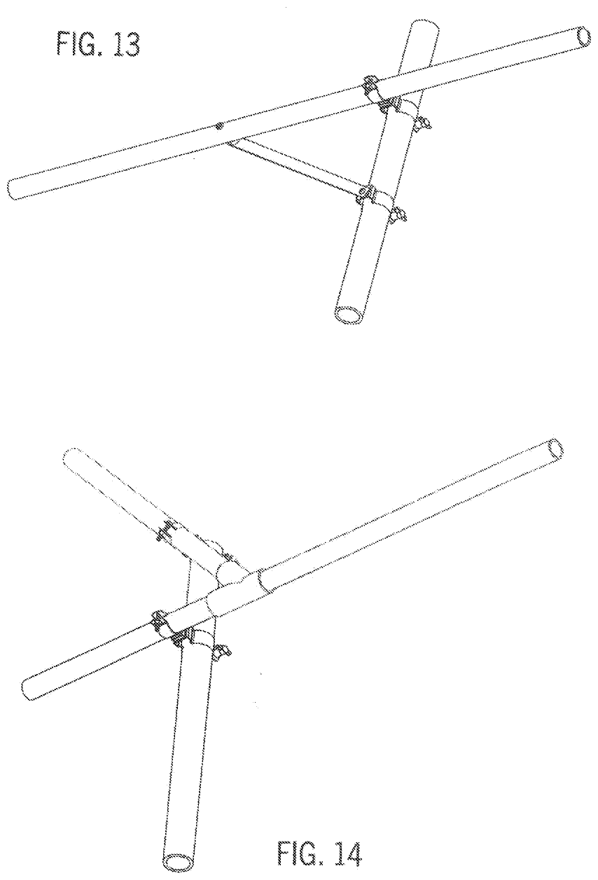

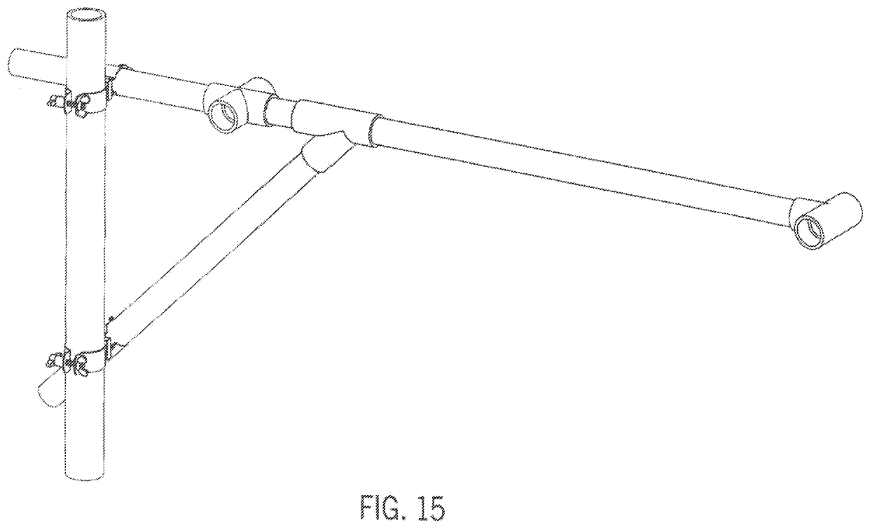

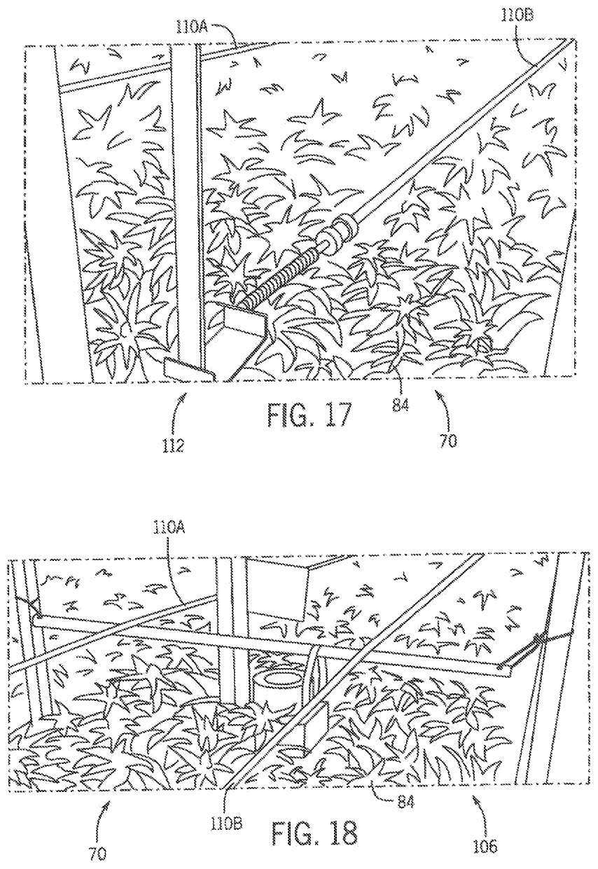

FIGS. 13 and 14 arc other views of the support shown in FIGS. 11 and 12, respectively. FIGS. 15 and 18 show further alternative embodiments of the height adjustable midsection line support assemblies. FIG. 17 shows an alternative of a height adjustable line 110 end support.

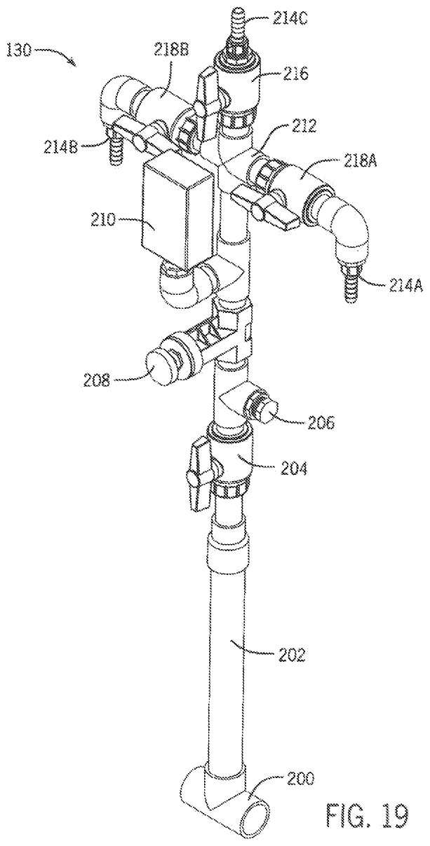

FIG. 19 shows further details of an embodiment of the gas supply manifold 130 shown also in FIG. 10. The manifold 130 comprises a gas input tee 200, a PVC riser 202, a PVC ball valve 204, a gate valve 206, a PVC pipe 208, a pressure transducer ionics 210, a PVC cross 212, a pair of hose barbs 214 A&B, a PVC ball valve 216, and a pair of PVC ball valves 218 A&B. The three flow controls 214A/B and 216 permit precise adjustment of CO2 delivery to the plural beds or bays 70.

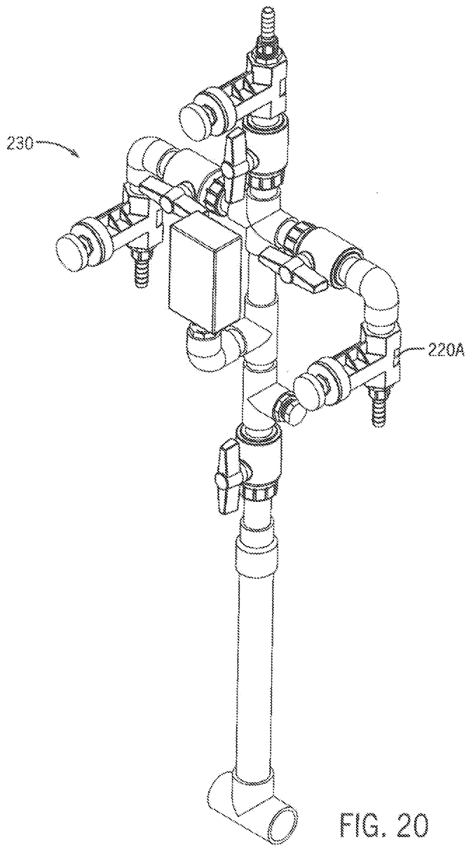

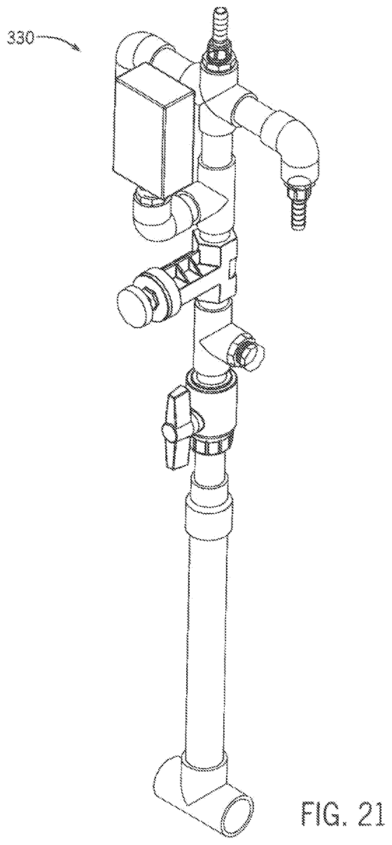

FIG. 20 shows an alternative embodiment of the manifold 230 with substantially similar features to the manifold 130, except that a pair of gate valves 220 A and B are added above hose barbs 21 A-D. The manifold 330 embodiment shown in FIG. 21 is a basic embodiment again similar to manifold 130, except that it lacks the pair of PVC ball valves 218 A&B.

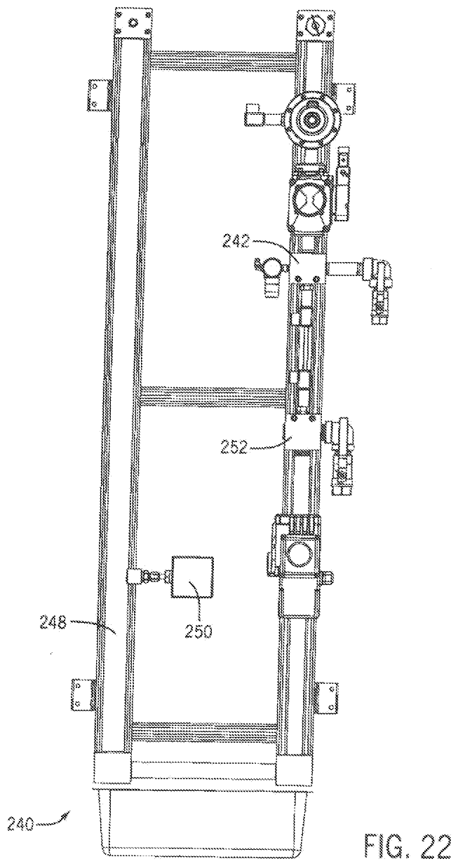

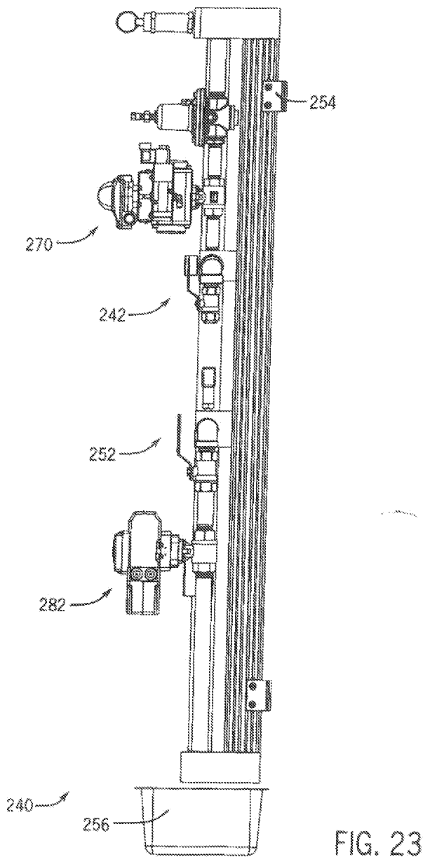

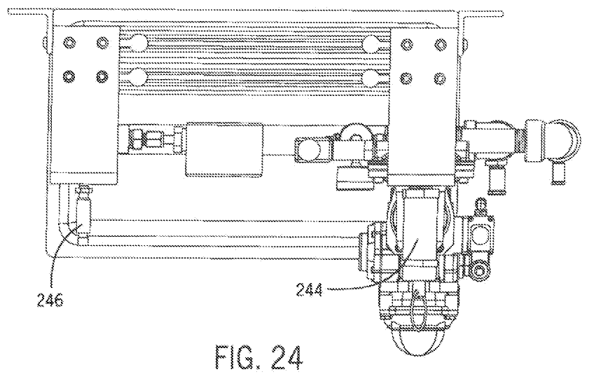

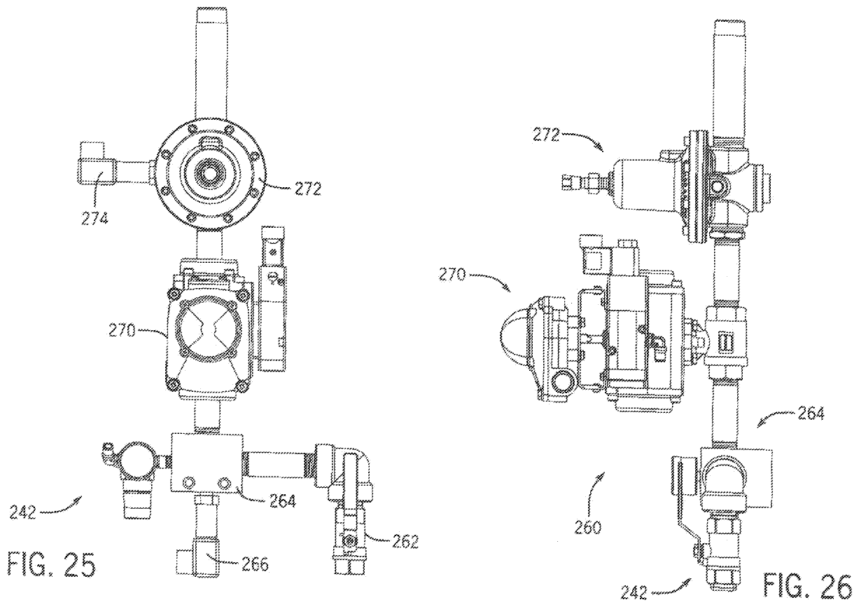

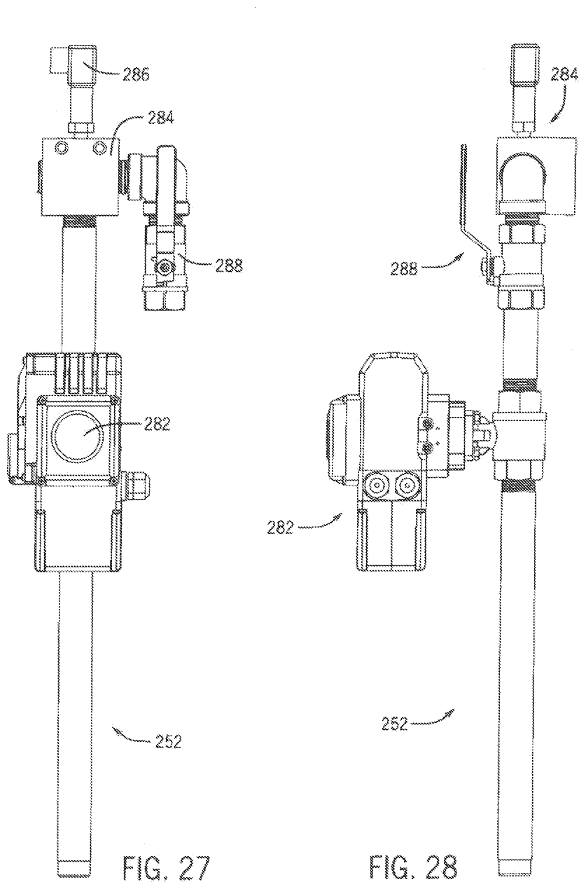

Returning to the discussion of the midstream subsection 14, an embodiment of the gas valve assembly 50 is shown in FIGS. 22-28. Referring first to FIGS. 22-24, the gas valve assembly 50 comprises a manifold assembly 240, an input valve assembly 242 connected to the manifold assembly 240 and an output valve assembly 252 also connected to the manifold assembly 240. Referring to FIGS. 22-24, the manifold assembly 240 includes the input valve assembly 242, a pressure-relief valve 244, a temperature sensor 246, a flow tube assembly 248, a flow meter 250, the output valve assembly 252, a mounting bracket assembly 254, and a drip pan 256. Referring to FIGS. 25 and 26, the input valve assembly 242 includes a ball valve 262. an input manifold 264, a pressure transducer 266, an air regulator, a ball valve 270, a gas regulator generant 272, and a pressure transducer 274. Referring to FIGS. 27 and 28, the output valve assembly 252 includes a ball valve and actuator 282, an output manifold 284, a pressure transducer 286. and a ball valve 288.

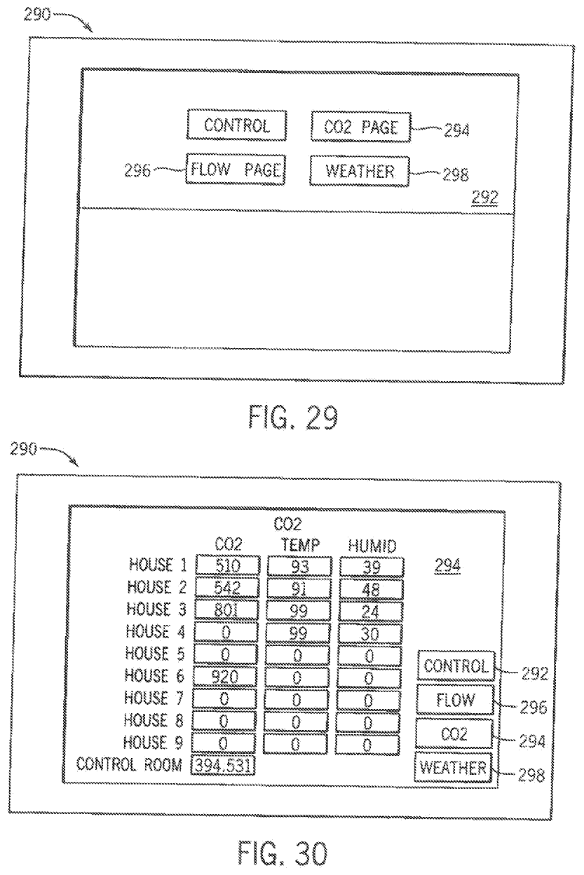

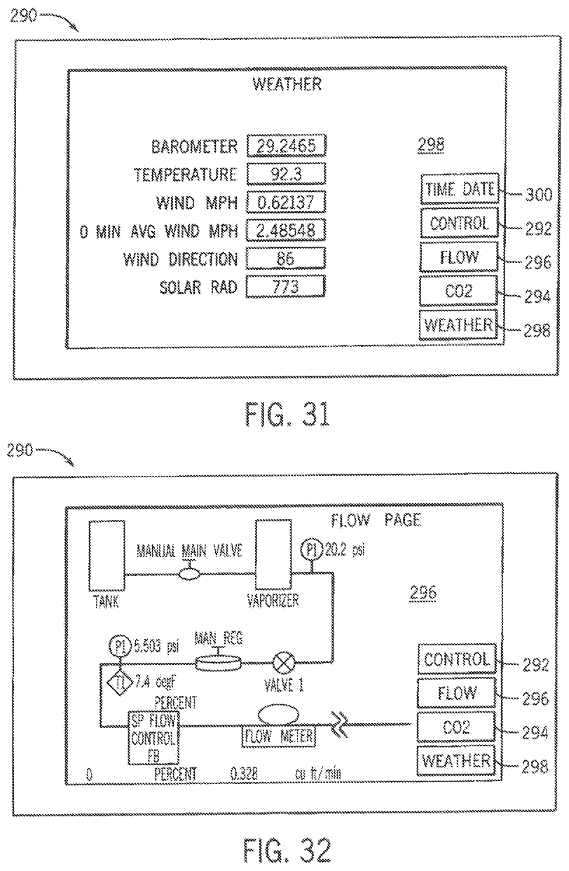

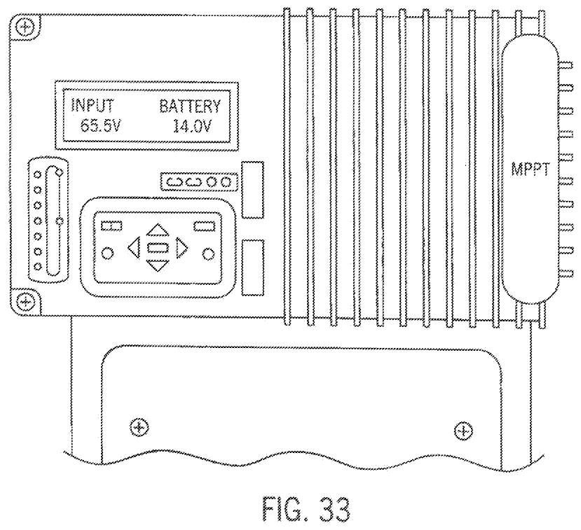

Further in the midstream subsection 14, and with reference to FIGS. 29-38, an embodiment of the electronic control assembly 52 comprises a user display and input device 290, preferably in the form of a touch screen controller. An example device is provided by Phoenix Contact of Middletown, Pa., USA. The electronic user control system initially presents a home screen or page 292, shown in FIG. 29, with CO2 status 294, CO2 flow 296, and weather 298 options. Referring also to FIG. 30, the CO2 status display shows the CO2 concentration, house temperature, and humidity for each of plural houses 18A-x. It also has buttons or switches 292-298 for moving to the other screens of the system. Referring also to FIG. 32, the CO2 flow screen shows the status of the lank, vaporizer and other gas flow parameters, and screen switches. This can be utilized to detect gas line leaks at any part of the system. Referring also to FIG. 31 live weather page 298 shows the operator temperature, wind speed and direction, and light intensity to permit adjustment of CO2 delivery. FIG. 33 shows an embodiment of the power control assembly of the system 52.

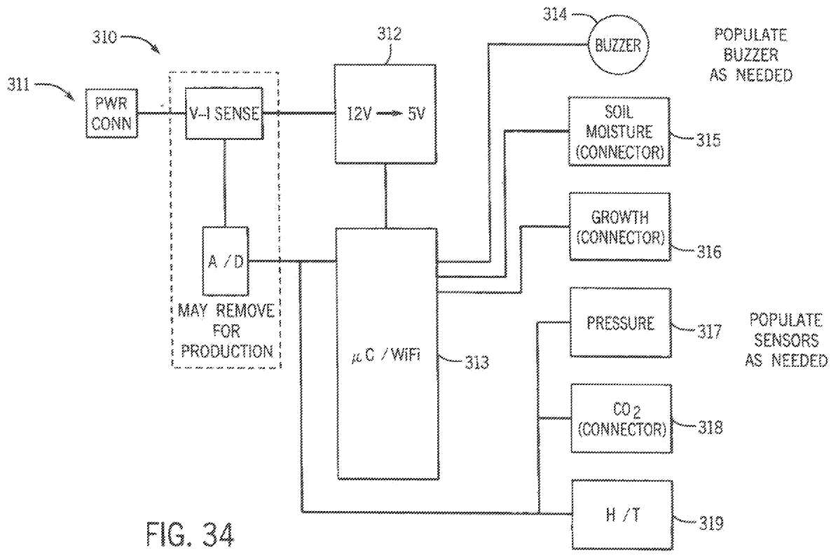

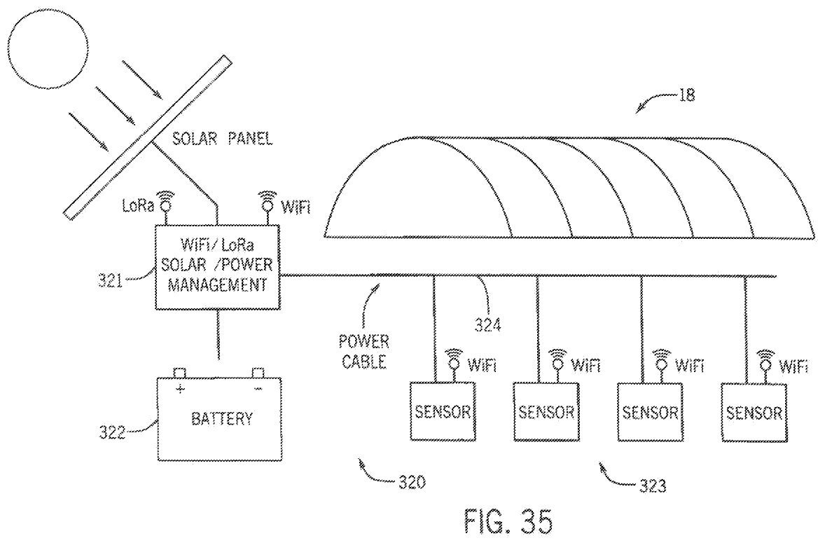

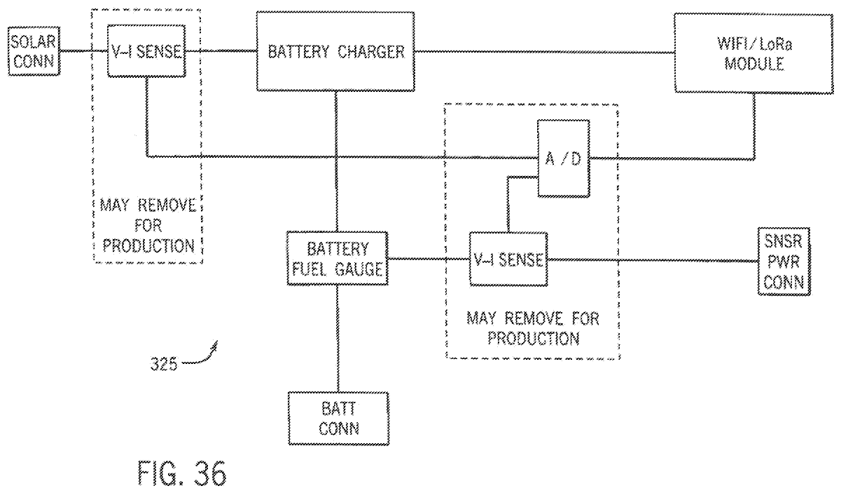

FIG. 34 is a diagram of an embodiment of a sensor module control and communication system 310 of the invention, including WIFI capability. The system 310 includes a power connector 311, a voltage converter 312, a WIFI module 313, an alarm 314, a soil moisture module 315, a plant growth module 316, a CO2 pressure sensor 317, a CO2 concentration sensor 318, and a high temperature sensor 319. FIG. 35 is a diagram of an embodiment of a hoop house electrical and communication system 320 including a power management module 321, a battery module 322, and an array of sensors 323. Each sensor in the array, preferably senses temperature, humidity, and CO2 concentration. Significantly, the multi sensors 323 are disposed on the height adjustable midpoint support assembly 106 so that they are positioned in close proximity to live top of the growing plant 86 canopy tor optimum sensitivity to plant CO2 needs. They receive power via a power cable array 324 for security, particularly in view of CO2 safety. They are shown to communicate data to the controller 52 via WIFI or other wireless transmission, but may be hard wired also. FIG. 36 is a diagram of an embodiment of a LoRa, WIFI, battery and power management module 325 of the invention.

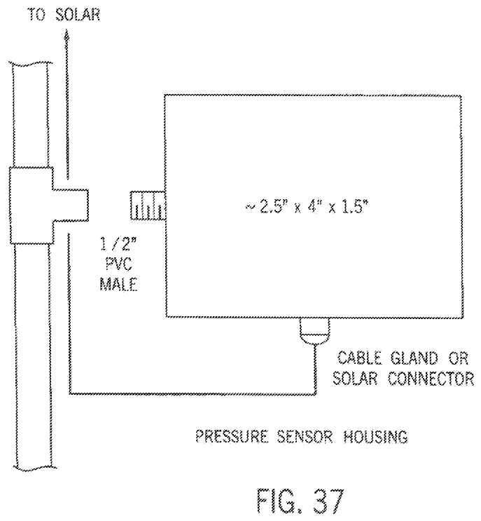

FIG. 37 illustrates an embodiment of a pressure sensor housing of the invention.

Returning to FIGS. 10-12, the method of constructing the height adjustable distribution and emission assemblies 130 (and for using such assemblies) for each bed 70 is discussed. Posts 112 and 114 are securely anchored to the ground at each end of the beds 70. The posts 112 are constructed and arranged such that they will not bend, even when inward pressure is applied to the top of the post 112/114. A wire or other line is extended the length of the row and attached to the corresponding post 112/114 at the far end of the bed 70. In one alternative embodiment, the wire element is a self supporting gas pipe. In another embodiment, the wire is the emitter line 110. The wire is connected on each end to an adjustable sliding sleeve that can slide up or down on the post. The sleeve has the ability to lock or maintain to a fixed elevated position, that is height on the post, and is easily repositioned upwards or downwards to a new position as needed. The wire is tensioned generally tautly using any number of commercially available tensions like 3 ratchet strap, inducing minimal deflection down the length of the row from the far end post which also has the same slider arrangement. Cross members or aerial ties can be used intermittently down the row to support deflection in the emitter run as desired, for example a 3-20 foot spacing to create a scallop effect down the length of the row, but generally supporting the emitters at an equally desirable height at or just above the top of the plants from one end of the bed to the other.

Emitters (not shown) and gas supply are supplied down the length of the wire/bed row. Emitters are positioned just above the canopy of the crop. Returning to FIG. 38, in use, as the crop 84 grows, the sliders at each end are moved up the posts as need to accommodate plant growth and to stay clear of the introduction of mesh trellis in the bed as is commonly known and used in the cultivation of Cannabis or other such crops. Rigid to semi-rigid emitters are suspended just at or above the leafy canopy of a single plant or row of the crop. Upward mobility of the device is permitted to correspond to plant growth. They may be removed or moved out of the way to facilitate harvest and other agronomic functions like the introduction of mesh.

The system of the invention can be extended to the control of pests such as mites. The infested plants can be tented with a sealed plastic fabric cover and the gas is introduced for a period of around 15 minutes at higher concentrations above 10,000 PPM to organically kill all of the pests on the plants. Multiple plants in that garden can be tented at once and a whole group can be cleansed of pest at once either through a single tent or multiple tents.

The system may incorporate applicants' multi-media irrigation technology to accommodate conductance of a variety of liquids, gases, aerosols, volumes and flow rates. Gaseous conductance can include thermally treated air, such as cooled air drawn across an ambient vaporizer present, and reverse flow direction for odor control and humidity control practices. Curtains can be provided between the rows of the system, to isolate vectoring and maintain a variety of gaseous mixtures between adjacent rows. Further, a pass through enclosure with gaseous enrichment from the system can even be provided to suppress vector transmission as people, equipment and supplies enter and leave the production area.

### Stationary CO₂ Supply Sources

Applicants' invention is related to the dynamics of CO₂ supply. The diversity, sources and volume of CO₂ emissions are large and becoming less expensive. While some embodiments of the invention utilize liquified CO₂ tanks as the supply source of CO₂, there are a number of stationary CO₂ sources that can also provide the necessary CO₂ supply at a given location.

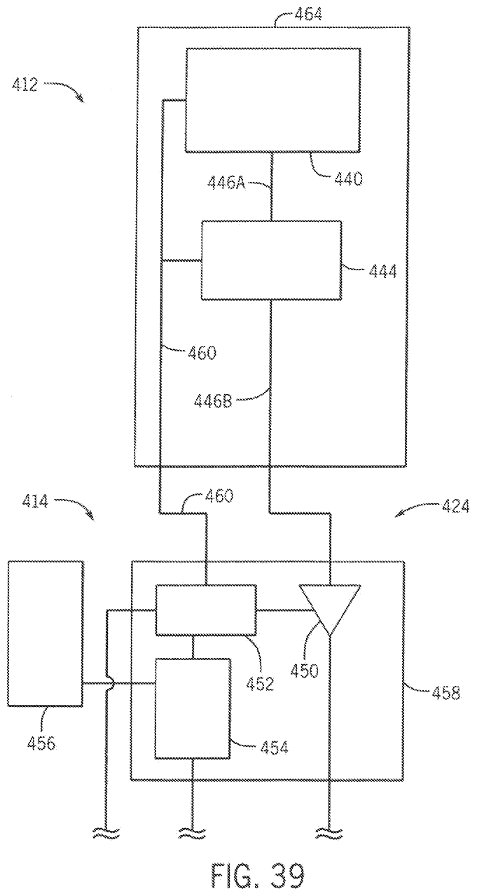

An alternative embodiment of the upstream subsection 412 is shown in FIG. 39. The subsection 412 preferably comprises a tank 440 and a vaporizer 444 connected directly to the tank 440 without an intervening pressure builder. The tank 440 holds liquid Carbon Dioxide (CO2). It has a bulk storage capacity of between 5 and 50 Tons of liquefied CO2. An exemplary tank is manufactured by Chart Industries of New Prague, Minn., USA. Alternative tanks may be supplied by others such as Matheson of Egan, Minn., USA. The tank 440 has a fill inlet 462. The vaporizer 444 is connected directly to the tank 440 via line 446B. It functions to convert CO2 in a liquid state from the tank 444 into a CO2 in a gas or gaseous state. CO2 gas exits outlet 446C at a pressure of between 200 and 400 psi., preferably 300 psi. An example vaporizer 444 is available from Doucette industries of York, Pa., USA. The upstream subassembly 412 is preferably secured by it's own security fence 464.

Still referring to FIG. 39, a preferred embodiment of midstream subsection 414 comprises a valve assembly 450, an electronic control assembly 452, and a power supply 454. These components are preferably located in a secure housing. In the preferred embodiment, they are shown disposed in a trailer 458. The valve assembly 450 is connected to the output 446C of the upstream assembly 412 and controls distribution of CO2 gas to the downstream system 416 via output 426A. The electronic control assembly 452 is communicatively connected to the valve assembly 450 and provides instructions to it distribution of gas. The electronic control assembly 452 is powered by power supply 454. The power supply 454 preferably contains batteries and AC power connections, The midstream section 414 also preferably has a solar array 456 for recharging the batteries of the power supply 454. The electronic control assembly 452 preferably has both direct wire connections and wireless (WIFI, RF or the like) connections to various sensors (temperature, humidity, CO2 concentration, light) disposed in the downstream section 416. The electronic control assembly 452 also preferably has means to connect remotely via hardwire telephone, CDMA cell and/or satellite transmission.

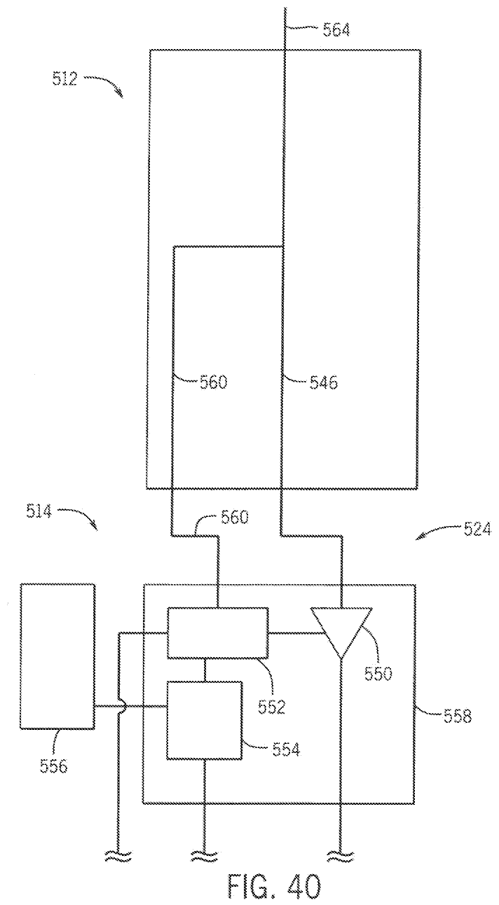

A further alternative embodiment of the upstream subsection 512 is shown in FIG. 40. The subsection 512 preferably comprises a direct connection to CO2 gas source 540, for example one deployed in close proximity to a CO2 manufacturing facility (i.e. an ethanol, ammonia or power generating plant) and be directly supplied therefrom. No vaporizer is required in this embodiment, CO2 gas exits outlet 546C at a pressure of between 200 and 400 psi., preferably 300 psi. The upstream subassembly 512 is preferably secured by it's own security fence 564.

Still referring to FIG. 40, a preferred embodiment of midstream subsection 514 comprises a valve assembly 550, an electronic control assembly 552, and a power supply 554. These components are preferably located in a secure housing. In the preferred embodiment, they are shown disposed in a trailer 558. The valve assembly 550 is connected to die output 546C of the upstream assembly 512 and controls distribution of CO2 gas to the downstream system 516 via output 526A. The electronic control assembly 552 is communicatively connected to the valve assembly 550 and provides instructions to it distribution of gas. The electronic control assembly 552 is powered by power supply 554. The power supply 54 preferably contains batteries and AC power connections. The midstream section 514 also preferably has a solar array 556 for recharging the batteries of the power supply 554. The electronic control assembly 552 preferably has both direct wire connections and wireless (WIFI, RF or the like) connections to various sensors (temperature, humidity, CO2 concentration, light) disposed in the downstream section 516. The electronic control assembly 552 also preferably has means to connect remotely via hardwire telephone, CDMA cell and/or satellite transmission.

Several emerging companies and established industrial gas companies are offering CO₂ capture technologies, including “Plug-n-Play” options such as Sustainable Energy Solutions. And while the present inventor can use relatively expensive truck deliveries of liquefied CO₂ (LCO2) into tanks, the emergence of new CO₂ capture technologies provides:
Potential for less expensive CO₂—less than $40 per ton, versus $250 per ton trucked LCO₂
Easy connection to existing sources offering a greater number of locations in direct CO₂ sourcing at the farms
Potential for lower risk, incremental investment and acreage rollout
Broader and greatly needed environmental benefits thusly, enhancing the market potential for the present invention's technology. “Upstream CO₂ Vendors” may both, offer significantly reduced costs and real and perceived environmental benefits and long-term impacts.
By far the most prevalent and widespread CO₂ sources are from the emission/flue gas created by the combustion of fossil fuels. The present invention can take advantage of stationary combustion sources such as:
   Coal
   Natural gas (methane)
   Propane
   Petroleum
   Any hydrocarbon combustion site is a potential source of CO₂, although said emission—flue gas may require refinement to achieve purity levels necessary so that the gas is not toxic to the plants

Non-stationary combustion sources such as: automobiles, trucks, airplanes, trains and the likes are not suitable as CO₂ sources for the present invention. Blue Hydrogen″ calls for the decarbonization of methane/natural gas and produces a lot of CO₂; is when natural gas is split into hydrogen and CO₂ either by Steam Methane Reforming (SMR) or Auto Thermal Reforming (ATR), but the CO₂ is captured and then stored. As the greenhouse gasses arc captured, this mitigates the environmental impacts on the planet. Several entities are active in this area including: Nu:ionic Technologiesm Proteum Energy (ach H₂ modules produce approximately 70 TPD of purity CO₂). Chart Industries, Baker Hughes, Air Products & Chemicals, and Cummins. The European Clean Hydrogen Alliance has over 1,400 member companies and institutions. Fuel Cells entities include Ballard Power Systems, FuelCell Energy, Bloom Energy, Plug Power, and Carbon Capture Technologies. Global Thermostat proposes using low-grade waste heat can extract CO₂ from ambient air and/or from many other CO₂ streams including Hue gas or even DAC (Direct Air Capture) from ambient air. Sustainable Energy Solutions of Ogrem, Utah—their trademarked process called Cryogenic Carbon Capture. Inventys—British Columbia based new technology uses carbon fibers to capture CO₂ or even DAC (Direct Air Capture) from ambient air. Climeworks—Zurich Switzerland based, captures CO₂. Akermin, Inc.—St. Louis based CO₂ capture at first full-scale demonstration phase. Amine processors are the oil and gas industry standard used to refine “associated gas” produced from mined natural oil & gas wells—to strip CO₂ from natural gas, to upgrade the natural gas for pipeline transport. Production of ammonia fertilizer from natural gas utilizing the Haber-Bosch process. Skyonic an emerging Canadian CO₂ capture company converts CO2 to fertilizer

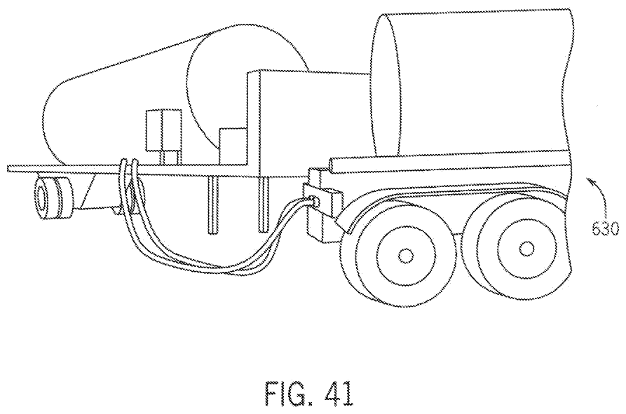

Currently marketed Food Grade liquefied CO₂—(“LCO₂”) is derived primarily from ethanol plants and refineries with hydrogen reformers. LCO₂ can serve both as pilot phase supply for AG Gas® and for certain longer-term market needs. Referring to FIG. 41, logically, truck 630 transportation of LCO₂ is energy intensive and more expensive at distance.

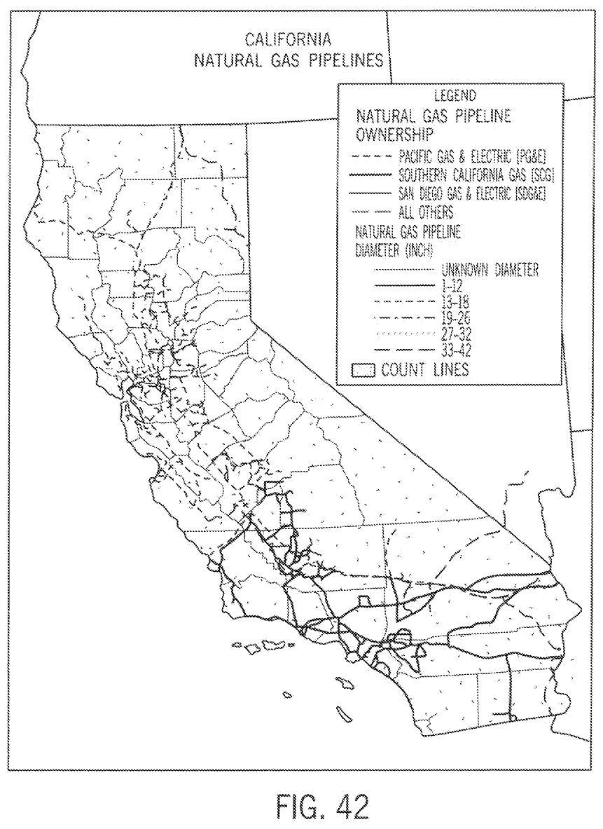

Referring to FIG. 42, Pacific Gas and Electric (in northern Central Valley) and Sempra Energy's—So. Cal Gas (in the southern Central Valley) have extended a vast net of natural gas pipelines and distribution networks in in Central Valley, offering an opportunity for low cost CO₂ using CBUs—Combustion Based Units. CBUs are portable generators with CO₂ capture that are readily transported, installed, and coupled to a natural gas pipe: basically “Plug-in-Play” CO₂ supply. This will be “distributed electrical generation” which meets with California legislative mandates; the electricity produced can be grid connected and used to power localized demand and irrigation pumps. CBUs provide AG Gas with logistical flexibility for sourcing inexpensive CO₂ near farms reducing dependence on LCO₂ trucks.

Longer term, PG&E's natural gas network extends into the very large Oregon and Washington orchard markets and Sempra Energy's gas network extends through AG Gas markets in Arizona, New Mexico, Texas and includes notable assets in Mexico.

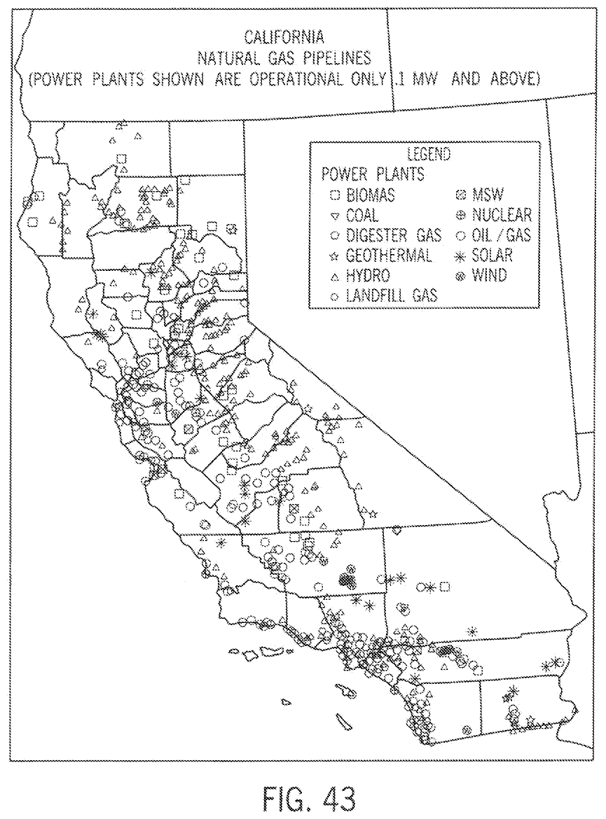

Referring to FIG. 43, there is a lot of oil production (with associated CO₂ gas) in Central Valley California. Currently, the CO₂ is separated and mostly deep-well injected, a costly method of disposal. CO₂ is a byproduct of every combustion process and CO₂ flue gas is available in a wide range of purity grades from existing industrial and utility sources. CO₂ generally constitutes about 4-15% of a combustion emission stream, which is mostly comprised of water vapor, and some smaller amounts of harmful pollutants. There are many sources of combustion flue gas in California within the target market. When refining the organic carbon (CO₂ from flue gas), the associated air pollutants can be removed and eliminated from emission into our environment.

Naturally occurring geological CO₂ reserves offer the potential of an ultra-low cost CO₂ source. Certain sites exist that could be very valuable for employing geologic CO₂ where pipelines intersect areas of high value agricultural production and orchards. While the far less expensive geologic CO₂ will support wider margins and a broader crop value spectrum, the downside of this source is a potential net release of CO₂ to the atmosphere (depending on a host of variables: fuel savings, water savings, production gains and soil sequestration and the like).

Pure CO₂ is a primary byproduct of ethanol fermentation. The ethanol industry and thus CO₂ production is being encouraged by the ban of MTBE (a gasoline octane additive) in California as well as other areas with similar proposed environmental regulations governing automobile emissions. As a result, a few ethanol plants have been constructed in Central Valley, Calif.

Ethanol plants use agricultural crop products as a feed stock: in the U.S. primarily corn and in Brazil primarily sugarcane. Ethanol produces almost pure CO₂, unlike combustion of fossil fuels which has a much lower percent and dirtier CO₂ stream. Brazil has a large ethanol industry based on the production and conversion of sugarcane.

The U.S. farm and ethanol industries enjoy broad Congressional support and resulting heavy subsidies with the support of corn-belt state legislators. Unfortunately, however, the U.S. corn-based ethanol industry has been fraught with volatility. Moving forward, according to the California Bioenergy Action Plan:
For biofuels, the state shall produce a minimum of 20 percent of its biofuels within California by 2010, 40 percent by 2020, and 75 percent by 2050
For biomass for electricity, the state shall meet a 20 percent target within the established state goals for renewable generation for 2010 and 2020
For example, state's biofuel target for 2020 is over 2 billion gallons per year with a minimum of 40 percent produced within California. This should generate over 2 million tons of annual CO₂ emissions at the biofuels production facilities. (2M tons is for only California (2B gallons fuels×40%×6 pounds CO₂ per gallon fuels)=over 2M tons CO₂ within California)

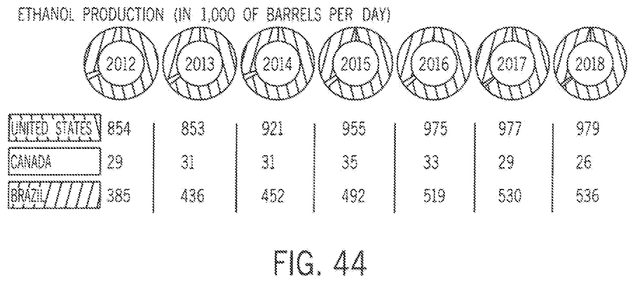

Referring to FIG. 44, the growth in bioenergy could be a positive factor and serve as an additional source of CO₂ near farmlands and orchards.

Oxygen enriched hybrid combustion technology emits a pure grade of CO₂ emissions suitable for Carbogation. See www.cleanenergysystems.com—a complimentary upstream technology.

Another stationary CO₂ source is from the production of ammonia fertilizer, which spins off a molecule of pure CO₂ when producing Ammonia from natural gas/methane. Most ammonia fertilizer is produced through the Haber-Bosch process. Mass production of ammonia mostly uses the Haber-Bosch process, a gas phase reaction between hydrogen (H2) and nitrogen (N2) at a moderately-elevated temperature (450 C) and high pressure (100 standard atmospheres in:

(10 MPa)): {N2+3 H2->2 NH3}}\quad \Delta H\hat{ }{\circ}=−91.8˜{\text{kJ/mol}}}

This reaction is both exothermic and results in decreased entropy, meaning that the reaction is favored at lower temperatures and higher pressures. This makes it difficult and expensive to achieve, as lower temperatures result in slower reaction kinetics (hence a slower reaction rate) and high pressure requires high-strength pressure vessels that aren't weakened by hydrogen embrittlement. In addition, diatomic nitrogen is bound together by an exceptionally strong triple bond, which makes it rather inert. Both the yield and efficiency of the Haber-Bosch process are low, meaning that ammonia produced must be continuously separated and extracted for the reaction to proceed at an appreciable pace. [123] Combined with the energy needed to produce hydrogen[note 1] and purified atmospheric nitrogen, ammonia production is a very energy-intensive process, accounting for 1 to 2% of global energy consumption, 3% of global carbon emissions, and 3 to 5% of natural gas consumption.

Methane digesting—biogas production produces about 40% CO₂ for 60% methane production. Biogas is being mandated in California, so more CO₂ could become available in the California market.

Production of natural gas from shale has become widespread in the United States. Natural gas is almost always associated with a significant percentage of CO₂ gas, which must be removed. Shale gas production is occurring in many states notably Pennsylvania which has regions of high value crop production.

Cement manufacturing and electricity generation from geothermal steam, both produce large quantities of CO₂. There arc these types of facilities in California and are under political pressure to find beneficial uses and sequestration for their CO₂.

Two other potentially large sources of CO₂ result as a byproduct of coal gasification in North Dakota and as a byproduct of tar and oil sands refinement in Alberta, Canada.

Most food grade CO₂ is derived as a byproduct from refineries employing hydrogen units, ethanol production, and ammonia fertilizer plants. Generally, marketers install CO₂ capture, purification and liquefaction plants at these source facilities. The CO₂ is chilled to a liquid state to be transported by refrigerated tank truck to various sales points. Approximately half of food grade CO₂ is sold for food freezing, processing and packaging as well as soft drink carbonation. The next largest users are pulp and paper manufacturers. CO₂ is also used for water purification, dry ice, fumigation, and a number of medical and industrial uses. A larger application for non-food grade CO₂ is as an injectant into hydrocarbon reservoirs to stimulate production from mature oil fields, known as EOR—Enhanced Oil Recovery. This market is supplied mostly by production from huge underground reservoirs of essentially pure CO₂ or from CO₂ associated with and separated from natural gas. Over 1.5 billion cubic feet per day of CO₂ is used in enhanced oil recovery in the U.S.

There is much research and development in the CO₂ market space and developing markets for desalinization, GTL gas to liquids, chemical processes, conversion to fuels, conversion to fertilizer, use in algae farms and other innovative uses for CO₂. Depending on capture, refinement, transport, storage, and distribution dynamics, CO₂ can be fairly energy intensive and therefore pricing may directly correlate to energy market fluctuations.

### Emitter Lines

The challenge that we resolve with “drip tape” is nearly-uniform delivery of gas along the entire length of a bed of plants. We currently have installations where the beds are upwards of 100 feet in length. The irrigation industry supplies technology that meets this requirement for distributing water; which has been re-purposed by applicant to deliver CO₂ gas. Tests have found successful gas uniformity up to 1,250 feet/a quarter mile.

Applicants' assignee has tested and used a variety of manufacturers' tapes, including T-System's T-Tape, Notation and a Toro product called Aqua-Traxx Azul. The manufacturers' products come in different configurations of emitter spacings (from 4″ to 24″) that are suited to various flow rates. Tube diameter in this product line also vary, from ⅝″ to 1⅜″. Wall thickness varies from 4 to 15 mil. These products are designed to distribute water, not gas, so its ratings are measured in gallons per hour. The product selected for a given project is based on variables, including: crop type, local environmental conditions, and cost and type of CO₂ source.

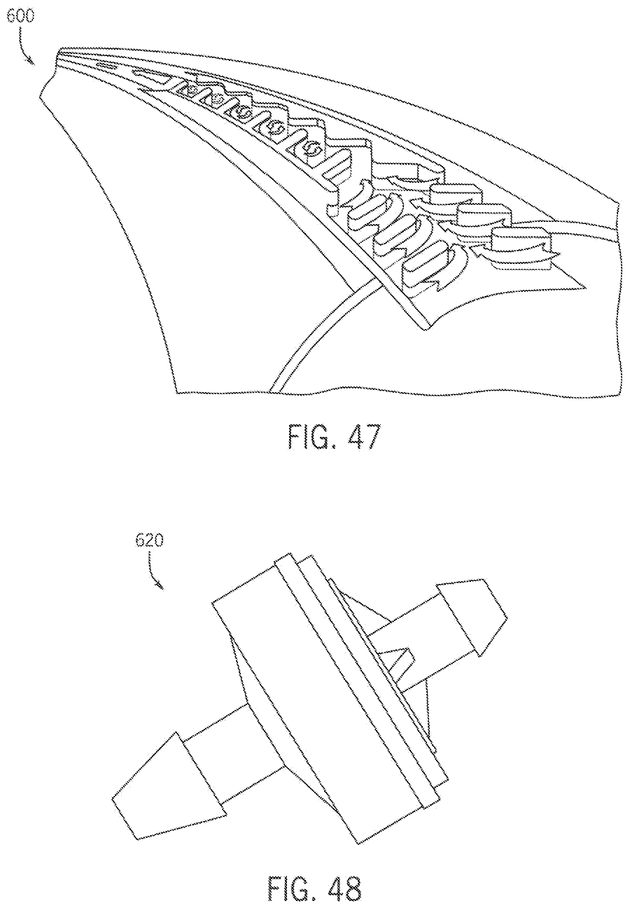

Referring to FIG. 47, one embodiment of the emitter conduit useable with the system of the invention is drip tape 600. It produces maximum consistency of flow across long distances, so that the rate of water being emitted at the distal end is—to the greatest extent possible—the same as the rate of water being emitted at the proximal end. An exemplary product, manufactured by Toro, has a coefficient of variation (Cv) of less than 3% when used to distribute water. The diagram depicts how this “arduous path emitter” technology works. The emitter orifices are essentially “slits” and not round openings. The slits are approximately ⅛ in length.

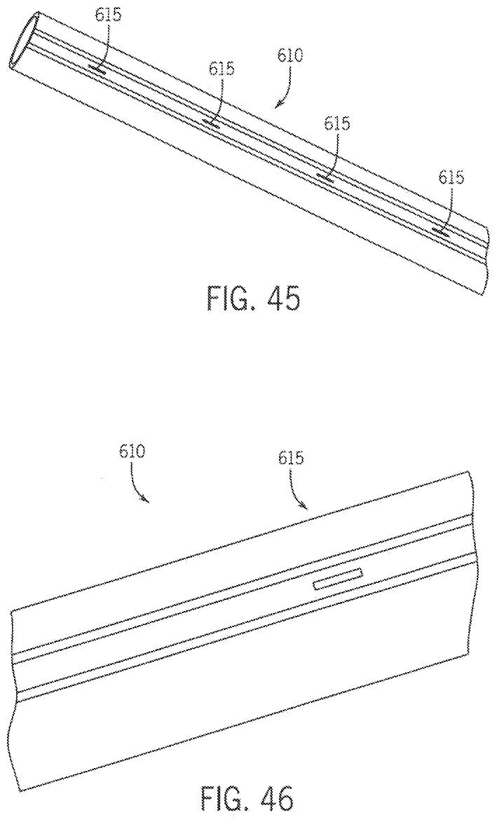

Referring to FIGS. 45 and 46, an alternative emitter utilizes a more rigid tube 610, versus a “tape” that inflates when in use. It has slits 615 having a length of approximately ⅛ length. A different means of achieving desired flow rates is to use inexpensive standard tubing and insert pressure-compensating drippers—sometimes described as “woodpeckers”—at desired intervals. FIG. 48 shows a woodpecker 620 supplied by Netafim:

The embodiments above are chosen, described and illustrated so that persons skilled in the art will be able to understand the invention and the manner and process of making and using it. The descriptions and the accompanying drawings should be interpreted in the illustrative and not the exhaustive or limited sense. The invention is not intended to be limited to the exact forms disclosed. While the application attempts to disclose all of the embodiments of the invention that are reasonably foreseeable, there may be unforeseeable insubstantial modifications that remain as equivalents. It should be understood by persons skilled in the art that there may be other embodiments than those disclosed which fall within the scope of the invention as defined by the claims. Where a claim, if any, is expressed as a means or step for performing a specified function it is intended that such claim be construed to cover the corresponding structure, material, or acts described in the specification and equivalents thereof, including both structural equivalents and equivalent structures, material-based equivalents and equivalent materials, and act-based equivalents and equivalent acts.

1. A system of promoting plant growth and production for plants growing in beds in elongated rows, comprising a CO2 gas supply; a gas controller communicatively connected to the gas supply; and at least one CO2 gas emitter communicatively connected to the gas controller, the at least one CO2 gas emitter being adapted to be aligned with, and disposed directly over, a row of growing plants, the at least one gas emitter being height adjustable whereby as the plants grow, the at least one gas emitter may remain in close proximity to the growing plants, the at least one CO2 gas emitter comprising a first support post disposed at one end of the row of growing plants, a second support post disposed at an opposite end of the row of plants, and an elongated, flexible gas emission conduit disposed between the first and second support posts, the emission conduit having a first end connected to the first support post and a second end connected to the second support post, the emission conduit having a plurality of gas emission orifices, the emission conduit being aligned in a straight line directly over the row of growing plants, the height of the emission conduit being adjustable by changing a vertical position of connection of the first end of the emission conduit to the first support posts and by changing a vertical position of connection of the second end of the emission conduit to the second support post, the emission conduit having an outside diameter of approximately ⅝ inch, whereby the emission conduit may be disposed in close proximity with the growing plants to distribute CO2 gas to the growing plants as the plants grow, and whereby the emission conduit permits light to access the growing plants; wherein the gas supply includes a liquid CO2 tank and a vaporizer connected directly to the CO2 tank to convert liquid CO2 to CO2 gas.

2. The system of claim 1, wherein the gas controller includes a gas input valve communicatively connected to the gas supply, a gas manifold communicatively connected to the input valve, and an output valve communicatively connected to the gas manifold.

3. The system of claim 2, wherein the gas input valve is connected to the vaporizer.

4. (canceled)

5. (canceled)

6. (canceled)

7. (canceled)

8. (canceled)

9. (canceled)

10. (canceled)

11. (canceled)

12. The system of claim 1, wherein:
a. the gas controller includes a gas input valve communicatively connected to the vaporizer, a gas manifold communicatively connected to the input valve, and an output valve communicatively connected to the gas manifold; and
b. the at least one gas emitter includes a gas manifold connected to the output valve, and to the elongated, flexible gas emission conduit.

13. (canceled)

14. The system of claim 1, further comprising at least one hoop house having at least one elongated bed adapted to grow plants, in at least one row, the at least one bed being disposed substantially on grade, and wherein the at least one bed is constructed on a single level in the hoop house.

15. (canceled)

16. A system of promoting plant growth and production for plants growing in beds in elongated rows, on a single level, comprising:
a. a CO2 gas supply, the gas supply includes a liquid CO2 tank and a vaporizer connected directly to the tank to convert liquid CO2 to CO2 gas;
b. a gas controller communicatively connected to the gas supply, the gas controller includes a gas input valve communicatively connected to the vaporizer, a gas manifold communicatively connected to the input valve, and an output valve communicatively connected to the gas manifold;
c. at least one CO2 gas emitter communicatively connected to the gas controller and adapted to be aligned with, and disposed directly over, a row of growing plants, the at least one CO2 gas emitter being height adjustable, over a single level, whereby as the plants grow, the at least one CO2 gas emitter may remain in close proximity to the growing plants, the at least one CO2 gas emitter including: (i) a gas manifold connected to the output valve, and (ii) a flexible, elongated gas emission conduit connected to the gas manifold and having a plurality of gas emission orifices, the emission conduit being aligned in a straight line directly over a row of growing plants, (iii) a first support post disposed at one end of the row of growing plants, and (iv) a second support posts disposed at a second end of the row of growing plants, the emission conduit having a first end connected to the first support post and a second end connected to the second support post, the height of the emission conduit being adjustable by changing a vertical position of connection of the first end of the emission conduit to the first support posts and by changing a vertical position of connection of the second end of the emission conduit to the second support post, the emission conduit having an outside diameter of approximately ⅝ inch, whereby the emission conduit may be disposed in close proximity with the growing plants to distribute CO2 to the growing plants as the plants grow, and whereby the emission conduit permits light to access the growing plants; and
d. wherein each emission conduit is connected at two one ends via a tension adjustment assembly to a support post.

17. A system of promoting Cannabis plant growth and production in a hoop house for Cannabis plants growing in plural beds in elongated rows, on a single level, composing:
a. at least one hoop house having at least one elongated bed adapted to grow plants, in at least one row, the at least one bed being disposed substantially on grade and wherein the at least one bed is constructed on a single level;
b. a CO2 gas supply, the gas supply includes a liquid CO2 tank and a vaporizer connected directly to the tank to convert liquid CO2 to CO2 gas;
c. a gas controller communicatively connected to the gas supply, the gas controller includes a gas input valve communicatively connected to the vaporizer, a gas manifold communicatively connected to the input valve, and an output valve communicatively connected to the gas manifold;
d. at least one CO2 gas emitter communicatively connected to the gas controller and aligned with, and disposed directly over, a row of growing plants, the at least one CO2 gas emitter being height adjustable whereby as the plant grows, the at least one CO2 gas emitter may remain in close proximity to the plant, the at least one gas emitter including: (i) a gas manifold connected to the output valve, and (ii) a pair of elongated gas emission conduits connected to the gas manifold, each conduit having a plurality of gas emission orifices, the emission conduits being height adjustable proximate the Cannabis plants, each gas emission conduit further comprising:
a first support post disposed at one end of the row of growing plants, and
a second support post disposed at a second end of the row of growing plants, each emission conduit having a first end connected to its respective first support post and a second end connected to its respective second support post whereby the emission conduit is aligned in a straight line directly over a row of plants, the height of the emission conduit being adjustable by changing a vertical position of connection of the first end of the emission conduit to the first support posts and by changing a vertical position of connection of the second end of the emission conduit to the second support post, the emission conduit having an outside diameter of approximately ⅝ inch whereby the gas emission conduit may be disposed in close proximity with the growing plants to distribute CO2 to the growing plants as they grow, and whereby the emission conduit permits light to access the growing plants:
e. wherein each emission conduit is connected at one end via a tension adjustment assembly to a support post; and
f. an electronic control system, the electronic control system being communicatively connected to the gas controller to control distribution of gas therefrom.

18. The system of claim 17, wherein the at least one hoop house:
a. has a ceiling constructed of flexible plastic material that is at least semi-transparent to sunlight, and
b. has a ceiling height of between 5 and 9 feet.

19. A system of promoting plant growth and production for plants growing in beds in elongated rows, comprising a direct CO2 gas supply conduit; a gas controller communicatively connected to the gas supply conduit; and at least one CO2 gas emitter communicatively connected to the gas controller, the at least one CO2 gas emitter being adapted to be aligned with, and disposed directly over, a row of growing plants, the at least one gas emitter being height adjustable whereby as the plants grow, the at least one gas emitter may remain in close proximity to the growing plants, the at least one CO2 gas emitter comprising a first support post disposed at one end of the row of growing plants, a second support post disposed at an opposite end of the row of plants, and an elongated, flexible gas emission conduit disposed between the first and second support posts, the emission conduit having a first end connected to the first support post and a second end connected to the second support post, the emission conduit having a plurality of gas emission orifices, the emission conduit being aligned in a straight line directly over the row of growing plants, the height of the emission conduit being adjustable by changing a vertical position of connection of the first end of the emission conduit to the first support posts and by changing a vertical position of connection of the second end of the emission conduit to the second support post, the emission conduit having an outside diameter of approximately ⅝ inch, whereby the emission conduit may be disposed in close proximity with the growing plants to distribute CO2 gas to the growing plants as the plants grow, and whereby the emission conduit permits light to access the growing plants.

20. A system of promoting plant growth and production for plants growing in beds in elongated rows, comprising a CO2 gas supply; a gas controller communicatively connected to the gas supply; and at least one CO2 gas emitter communicatively connected to the gas controller, the at least one CO2 gas emitter being adapted to be aligned with, and disposed directly over, a row of growing plants, the at least one gas emitter being height adjustable whereby as the plants grow, the at least one gas emitter may remain in close proximity to the growing plants, the at least one CO2 gas emitter comprising a first support post disposed at one end of the row of growing plants, a second support post disposed at an opposite end of the row of plants, and an elongated, flexible gas emission conduit disposed between the first and second support posts, the emission conduit having a first end connected to the first support post and a second end connected to the second support post, the emission conduit having a plurality of gas emission orifices, the emission conduit being aligned in a straight line directly over the row of growing plants, the height of the emission conduit being adjustable by changing a vertical position of connection of the first end of the emission conduit to the first support posts and by changing a vertical position of connection of the second end of the emission conduit to the second support post, whereby the emission conduit may be disposed in close proximity with the growing plants to distribute CO2 gas to the growing plants as the plants grow, and whereby the emission conduit permits light to access the growing plants; wherein the gas supply includes a liquid CO2 tank and a vaporizer connected to convert liquid CO2 to CO2 gas; and wherein the gas supply further includes a pressure builder communicatively disposed between the tank and the vaporizer.

21. The system of claim 20, wherein the emission conduit has a circular crossectional configuration.

22. The system of claim 21, wherein the emission conduit has an outside diameter of approximately ⅝ inch.

23. The system of claim 21, wherein the emission conduit has generally circular emission apertures.

24. The system of claim 21, wherein the emission conduit has emission slits.

25. The system of claim 20, wherein the emission conduit has a substantially fiat crossectional configuration.

26. The system of claim 25, wherein the emission conduit has emission slits.
